(19) United States
(12) Patent Application Publication
(10) Pub. No.: US 2026/0303426 A1
(43) Pub. Date: Oct. 1, 2026

(54) METHOD AND APPARATUS FOR SUPPORT OF RECTANGULAR NON-UNIFORM MODULATION CONSTELLATIONS

(71) Applicant: Samsung Electronics Co., Ltd., Suwon-si (KR)

(72) Inventors: Caleb K. Lo, San Jose, CA (US); Joonyoung Cho, Portland, OR (US); Jianzhong Zhang, Dallas, TX (US)

(21) Appl. No.: 19/563,916

(22) Filed: Mar. 11, 2026

Related U.S. Application Data
(60) Provisional application No. 63/778,078, filed on Mar. 26, 2025.

(51) Int. Cl. H04L 27/26; H04L 1/00

(52) U.S. Cl. CPC H04L 27/26025; H04L 1/0003; H04L 1/0009; H04L 1/0025

(57) ABSTRACT

UE capability information indicating support for rectangular non-uniform modulation constellations (NUMCs) and rectangular NUMC configuration information are exchanged by a UE and BS. Based on an MCS indication corresponding to a rectangular NUMC, bits to be transmitted are mapped to the indicated NUMC and corresponding modulation symbols are transmitted. Configuration information may include indicator(s) enabling/disabling MCS index mapping to rectangular NUMCs, rectangular NUMC identifiers, or rectangular NUMC bit-to-symbol mappings, either as mapping tables or coefficient sets. UE assistance information may include UE trajectory, UE sensor information, or an MCS index for a recommended rectangular NUMC. A fallback indication or command for switching to conventional constellations may be sent from the UE to the BS or from the BS to the UE.

### CROSS-REFERENCE TO RELATED APPLICATION(S) AND CLAIM OF PRIORITY

This application claims priority under 35 U.S.C. § 119(e) to U.S. Provisional Patent Application No. 63/778,078 filed on Mar. 26, 2025. The above-identified provisional patent applications are hereby incorporated by reference in their entirety.

### TECHNICAL FIELD

This disclosure relates generally to wireless networks. More specifically, this disclosure relates to modulation constellations employed in wireless networks.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/New Radio (NR) mobile communications include massive antenna technologies, from legacy cellular frequency bands up to high frequencies, to provide beamforming gain and support increased capacity, new waveforms (e.g., new radio access technologies (RATs)) to flexibly accommodate various services/applications with different requirements, new multiple access schemes to support massive connections, etc.

### SUMMARY

This disclosure provides apparatuses and methods for wireless communications with rectangular non-uniform modulation constellations.

In one embodiment, a user equipment (UE) is provided. The UE includes a transceiver configured to send, to a base station, capability information including an indication of support for rectangular non-uniform modulation constellations. The transceiver is also configured to receive, from the base station, rectangular non-uniform modulation constellation configuration information. The transceiver is further configured to receive, from the base station, a modulation and coding scheme (MCS) indication. The UE also includes at least one processing device coupled to the transceiver. The at least one processing device is configured to map a plurality of bits to be transmitted to a rectangular non-uniform modulation constellation based on the MCS indication. The transceiver is configured to transmit modulation symbols corresponding to the rectangular non-uniform modulation constellation to which the plurality of bits were mapped.

In another embodiment, a method is performed by a user equipment (UE) in a wireless communications system. The method includes sending, to a base station, capability information including an indication of support for rectangular non-uniform modulation constellations. The method also includes receiving, from the base station, rectangular non-uniform modulation constellation configuration information. The method further includes receiving, from the base station, a modulation and coding scheme (MCS) indication. The method still further includes mapping a plurality of bits to be transmitted to a rectangular non-uniform modulation constellation based on the MCS indication. The method includes transmitting modulation symbols corresponding to the rectangular non-uniform modulation constellation to which the plurality of bits were mapped.

In yet another embodiment a base station (BS) is provided. The BS includes at least one processing device and a transceiver coupled to the at least one processing device. The transceiver is configured to receive, from a user equipment (UE), capability information including an indication of support for rectangular non-uniform modulation constellations. The transceiver is also configured to send, to the UE, rectangular non-uniform modulation constellation configuration information. The transceiver is further configured to send, to the UE, a modulation and coding scheme (MCS) indication. A plurality of bits to be transmitted are mapped to a rectangular non-uniform modulation constellation based on the MCS indication. The transceiver is still further configured to receive modulation symbols corresponding to the rectangular non-uniform modulation constellation to which the plurality of bits were mapped.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network 100 for use of rectangular non-uniform modulation constellations according to embodiments of the present disclosure;

FIGS. 2A and 2B illustrate example wireless transmit and receive paths for use of rectangular non-uniform modulation constellations according to embodiments of the present disclosure;

FIG. 3A illustrates an example UE for use of rectangular non-uniform modulation constellations according to embodiments of the present disclosure;

FIG. 3B illustrates an example gNB for use of rectangular non-uniform modulation constellations according to embodiments of the present disclosure;

FIGS. 4A through 4D illustrate several examples of rectangular modulation constellations with non-uniform spacing between constellation points that can be used to compensate for shaping loss in accordance with the present disclosure;

FIG. 5 illustrates an example of a 32-ary rectangular modulation constellation with non-uniform spacing for a lower code rate according to an embodiment of the present disclosure;

FIG. 6 illustrates an example of a 32-ary rectangular modulation constellation with non-uniform spacing for a higher code rate according to an embodiment of the present disclosure;

FIG. 7 illustrates an example of a 128-ary rectangular modulation constellation with non-uniform spacing for a lower code rate according to an embodiment of the present disclosure;

FIG. 8 illustrates an example of a 128-ary rectangular modulation constellation with non-uniform spacing for a higher code rate according to an embodiment of the present disclosure;

FIG. 9 shows an example of a Gray mapping for a 128-ary rectangular modulation constellation with non-uniform spacing according to an embodiment of the present disclosure;

FIG. 10 shows an example of a partition of a 32-ary rectangular modulation constellation with non-uniform spacing in the in-phase direction according to an embodiment of the present disclosure;

FIG. 11 is an example of the BLER performance of several rectangular modulation constellations with non-uniform spacing over an AWGN channel;

FIG. 12 is an example of the BLER performance of various 128-ary modulation constellations over an AWGN channel;

FIG. 13 is a flow diagram illustrating an example of UE operation to support rectangular non-uniform modulation constellations according to an embodiment of the present disclosure;

FIG. 14 is a flow diagram illustrating an example of BS operation to support rectangular non-uniform modulation constellations according to an embodiment of the present disclosure;

FIG. 15 is a flow diagram illustrating UE operation to support BS determination of MCS indication for rectangular non-uniform modulation constellation according to an embodiment of the present disclosure;

FIG. 16 is a flow diagram illustrating an example of BS operation to support BS determination of MCS indication for rectangular non-uniform modulation constellation according to an embodiment of the present disclosure;

FIG. 17 is a flow diagram illustrating an example of UE operation to support BS configuration of MCS indication for rectangular non-uniform modulation constellation according to an embodiment of the present disclosure;

FIG. 18 is a flow diagram illustrating an example of BS operation to support BS configuration of MCS indication for rectangular non-uniform modulation constellation according to an embodiment of the present disclosure;

FIG. 19 is a flow diagram illustrating an example of UE operation to support UE-initiated fallback to conventional modulation constellations according to an embodiment of the present disclosure;

FIG. 20 is a flow diagram illustrating an example of BS operation to support UE-initiated fallback to conventional modulation constellations according to an embodiment of the present disclosure;

FIG. 21 is a flow diagram illustrating an example of UE operation to support BS-initiated fallback to conventional modulation constellations according to an embodiment of the present disclosure;

FIG. 22 is a flow diagram illustrating an example of BS operation to support BS-initiated fallback to conventional modulation constellations according to an embodiment of the present disclosure;

FIG. 23 shows an example of a new MAC CE for the UE assistance information report according to an embodiment of the present disclosure;

FIG. 24 shows an example of a new MAC CE for the rectangular non-uniform modulation constellation fallback indication according to an embodiment of the present disclosure; and

FIGS. 25A and 25B illustrate examples of 16-ary and 64-ary square QAM constellations with uniform spacing between constellation points, with the bit-to-symbol mapping for each constellation point shown for reference.

### DETAILED DESCRIPTION

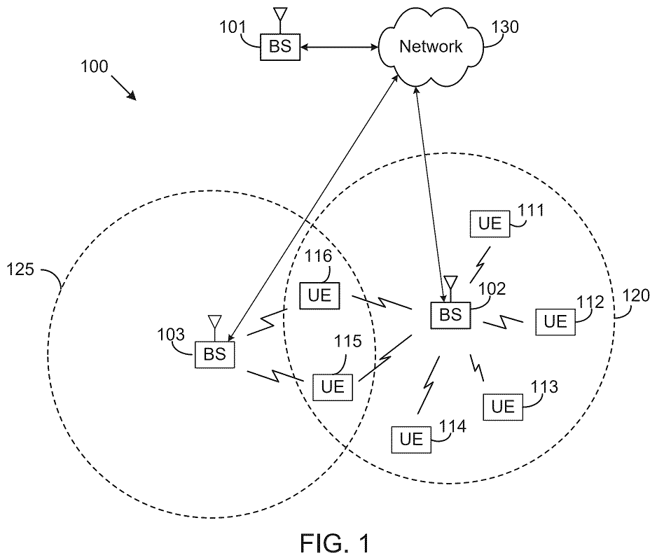

FIGS. 1 through 24, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

The following documents and standards descriptions are hereby incorporated by reference into the present disclosure as if fully set forth herein:
[1] 3GPP, TS 38.211, 5G; NR; Physical channels and modulation
[2] 3GPP, TS 38.331, 5G; NR; Radio Resource Control (RRC); Protocol specification
[3] 3GPP, TS 38.321, 5G; NR; Medium Access Control (MAC); Protocol specification
[4] 3GPP, TS 38.214, 5G; NR; Physical layer procedures for data
[5] S. Allpress, C. Luschi, and S. Felix, “Exact and approximated expressions of the log-likelihood ratio for 16-QAM signals”, Conference Record of the Thirty-Eighth Asilomar Conference on Signals, Systems and Computers, 2004. Vol. 1. IEEE, 2004.

### Abbreviations:

5G Fifth Generation
AI Artificial Intelligence
AWGN Additive White Gaussian Noise
BLER Block Error Rate
BS Base Station
CE Control Element
dB decibel
DCI Downlink Control Information
DL Downlink
IE Information Element
LLR Log-Likelihood Ratio
LSB Least Significant Bit
MAC Medium Access Control
MCS Modulation and Coding Scheme
ML Machine Learning
MSB Most Significant Bit
NR New Radio
NUC Non-Uniform Constellation
PDCCH Physical Downlink Control Channel
PUSCH Physical Uplink Shared Channel
QAM Quadrature Amplitude Modulation
RRC Radio Resource Control
RS Reference Signal
DMRS Demodulation Reference Signal
SNR Signal-to-Noise Ratio
SRS Sounding Reference Signal
UE User Equipment
UL Uplink

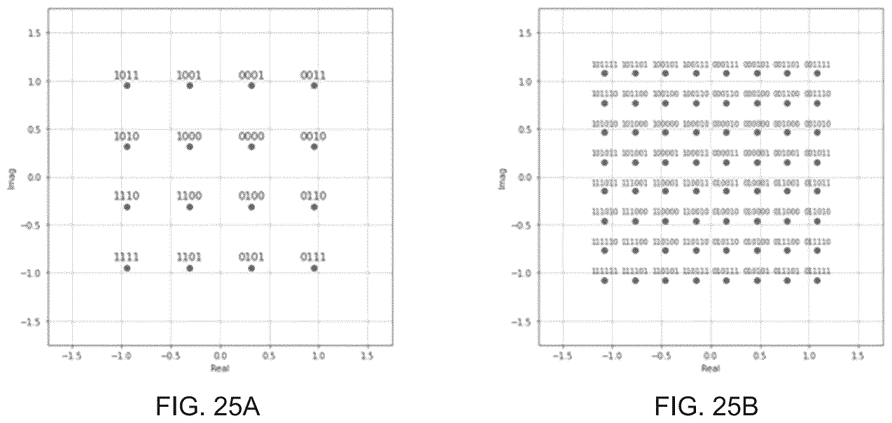

In a communication system, encoded bits are modulated to complex symbols from a constellation. The encoded bits are modulated according to one of several modulation methods such as QAM. Commercially adopted modulation methods use square constellations of the type illustrated by FIGS. 25A and 25B. The square QAM constellations in FIGS. 25A-25B have a shaping loss of up to 1.53 dB from the Shannon capacity bound, with one contributor to that shaping loss being the uniform spacing between constellation points. Square QAM constellations of order 16, 64, 256, and 1024 have been adopted in commercial systems [1]. However, due to uniform spacing between constellation points, such square QAM constellations may have a shaping loss of up to 1.53 dB from the Shannon capacity bound (i.e., considering the required SNR for a target data rate). A need exists to increase SNR from shaping loss to achieve target data rate and/or reduce power inefficiency.

Shaping loss can be reduced by using constellations with non-uniform spacing between points, for example in rectangular constellations (i.e., where the order is not a power of 4). It may be advantageous to apply a modulation method with non-uniform spacing to compensate for this shaping loss, as such modulation methods more closely resemble the capacity-achieving Gaussian signal distribution. Also, modulation methods with non-uniform spacing can be designed where the order is not a power of 4, e.g. order 32, 128; in certain cases, these methods can outperform methods where the order is a power of 4.

The present disclosure describes a framework for supporting additional rectangular modulation constellations with non-uniform spacing. The corresponding signaling details are discussed.

This disclosure addresses the issue that modulation constellations with uniform spacing have a shaping loss of up to 1.53 dB from the Shannon capacity bound. This disclosure provides methods that the network can use to configure additional rectangular modulation constellations with non-uniform spacing that compensate for this shaping loss.

Details on the support of methods for configuring additional rectangular modulation constellations with non-uniform spacing are disclosed, including information elements to be exchanged between a transmitter and a receiver.

Discussion of 5G systems and frequency bands associated therewith is merely for reference, as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems using rectangular non-uniform modulation constellations in accordance with the present disclosure. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 for use of rectangular non-uniform modulation constellations according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for low overhead CSI-RS transmission and CSI feedback. In certain embodiments, one or more of the gNBs 101-103 includes circuitry, programing, or a combination thereof, to support low overhead CSI-RS transmission and CSI feedback in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

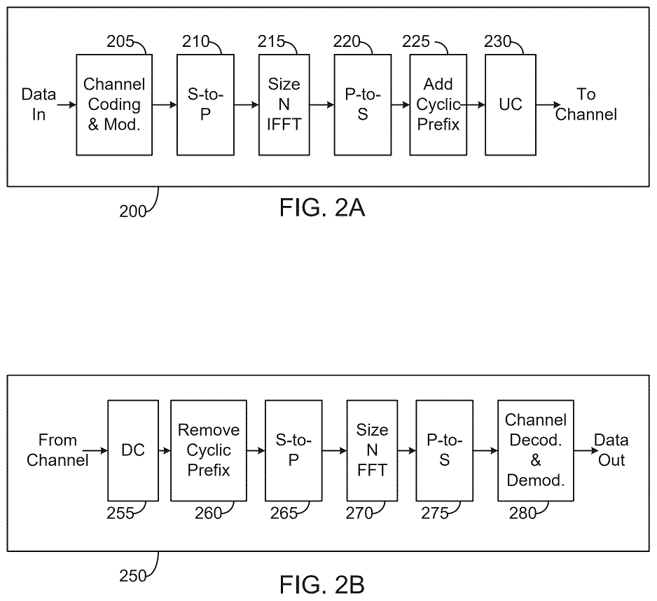

FIGS. 2A and 2B illustrate example wireless transmit and receive paths for use of rectangular non-uniform modulation constellations according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support low overhead CSI-RS transmission and CSI feedback as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

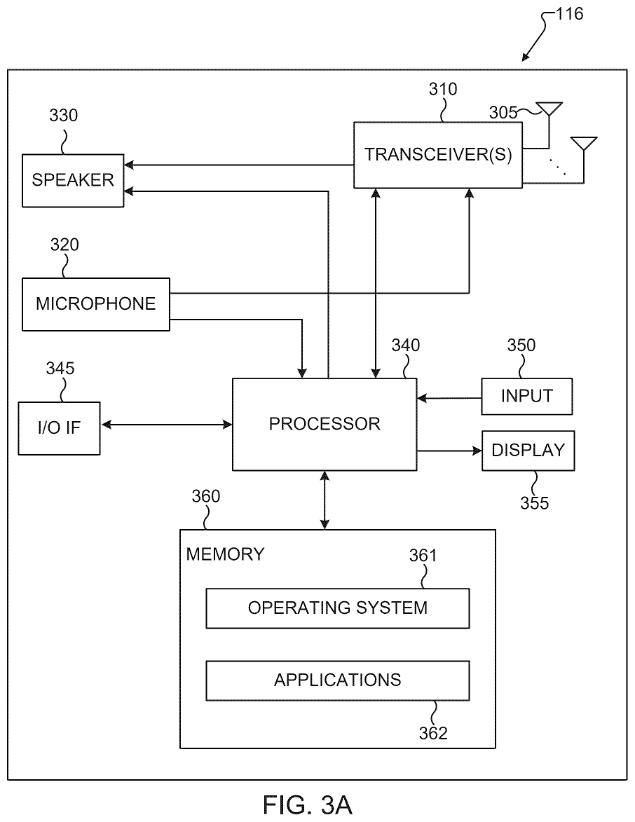

FIG. 3A illustrates an example UE 116 for use of rectangular non-uniform modulation constellations according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for low overhead CSI-RS transmission and CSI feedback as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 for use of rectangular non-uniform modulation constellations according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support low overhead CSI-RS transmission and CSI feedback as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

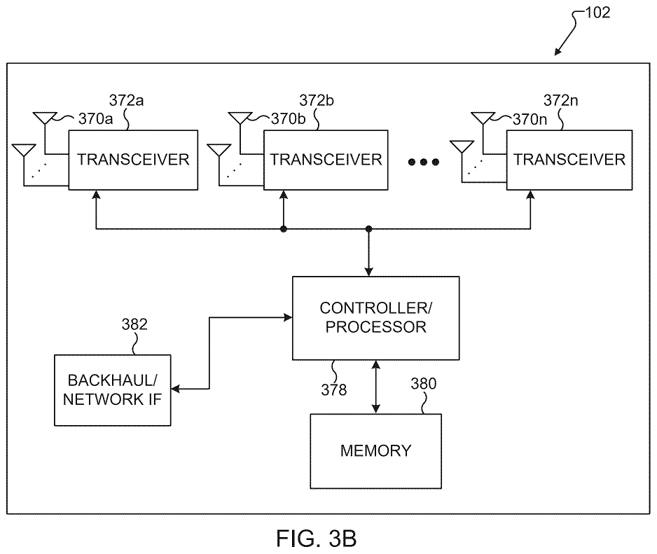

FIGS. 4A through 4D illustrate several examples of rectangular modulation constellations with non-uniform spacing between constellation points that can be used to compensate for shaping loss in accordance with the present disclosure. Each of these modulation constellations has been obtained via an artificial intelligence/machine learning (AI/ML) framework. The non-uniform spacing in these modulation constellations more closely matches that of the capacity-achieving Gaussian signal distribution. In addition, FIGS. 4A and 4C have orders that are not a power of 4 (i.e., 32 and 128, respectively). The shape of these modulation constellations differs from the square shape of the modulation constellations of FIGS. 4B and 4D, which have orders that are a power of 4 (i.e., 64 and 256, respectively). In addition, the rectangular shapes of all of these modulation constellations simplify log likelihood ratio (LLR) computations at the receiver, e.g. a lookup table can be used for implementation.

### Rectangular Modulation Constellations for Modulation Order 32

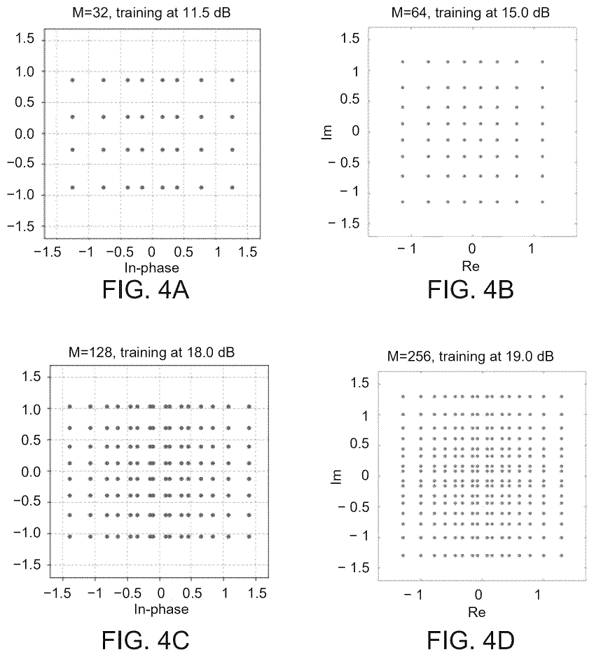

FIG. 5 illustrates an example of a 32-ary rectangular modulation constellation with non-uniform spacing for a lower code rate according to an embodiment of the present disclosure, with the bit-to-symbol mapping for each constellation point shown for reference.

For lower code rates, i.e., scenarios with lower target SNR values, embodiments of the 32-ary modulation constellation (such as that in FIG. 5) may be symmetric across all four quadrants, and may support Gray code mapping. In the example of FIG. 5, three bits can be mapped to one of eight in-phase values on the real axis, while two bits can be mapped to one of four quadrature values on the imaginary axis. In another example (not shown), two bits can be mapped to one of four in-phase values on the real axis, while three bits can be mapped to one of eight quadrature values on the imaginary axis. Additional combinations of bits for determining the in-phase and quadrature mappings can be supported.

Given that a total of five bits are used to determine the symbol mapping in the example in FIG. 5, packing three bits along the real axis requires non-uniform spacing between constellation points in that dimension for an energy-efficient modulation constellation. Also, as the target SNR value decreases, the optimal modulation order in terms of maximizing spectral efficiency decreases. This is equivalent to a 32-ary modulation constellation degenerating into a 16-ary modulation constellation, which is shown to a greater extent by the eight clumped pairs of constellation points on either side of the imaginary axis, and to a lesser extent by the outer pairs of constellation points. In addition, as fewer bits are packed along the imaginary axis, the spacing between constellation points in that dimension is more uniform.

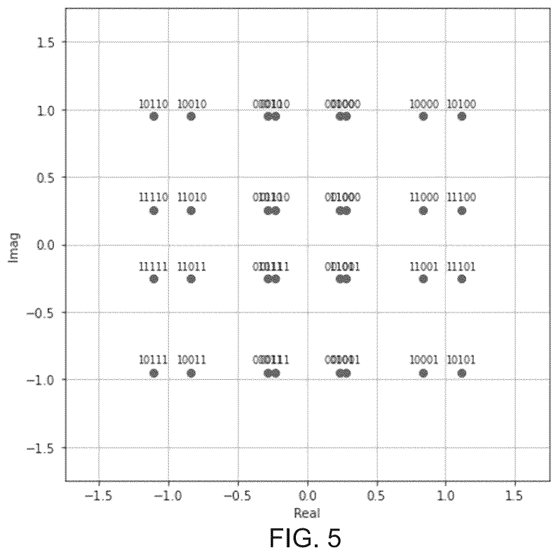

FIG. 6 illustrates an example of a 32-ary rectangular modulation constellation with non-uniform spacing for a higher code rate according to an embodiment of the present disclosure, with the bit-to-symbol mapping for each constellation point shown for reference.

For higher code rates, i.e., scenarios with higher target SNR values, an embodiment of the 32-ary modulation constellation in FIG. 6 is symmetric across all four quadrants and supports Gray code mapping. In this example, three bits can be mapped to one of eight in-phase values on the real axis, while two bits can be mapped to one of four quadrature values on the imaginary axis. In another example, two bits can be mapped to one of four in-phase values on the real axis, while three bits can be mapped to one of eight quadrature values on the imaginary axis. Additional combinations of bits for determining the in-phase and quadrature mappings can be supported.

Given that a total of five bits are used to determine the symbol mapping in the example in FIG. 6, packing three bits along the real axis still requires non-uniform spacing between constellation points in that dimension for an energy-efficient modulation constellation. Since the target SNR value in this example is higher than the example in FIG. 5, though, the spacing between constellation points in the real axis is more uniform in this example. This can be seen in the eight pairs of constellation points on either side of the imaginary axis, which are less clumped than those in FIG. 5. Again, as fewer bits are packed along the imaginary axis, the spacing between constellation points in that dimension is more uniform.

### Rectangular Modulation Constellations for Modulation Order 128

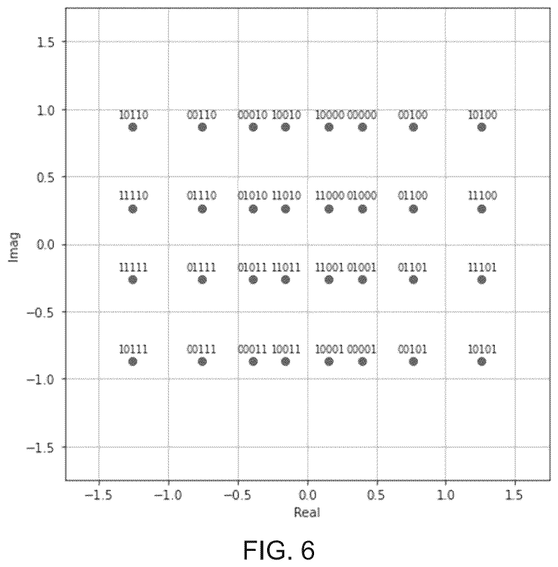

FIG. 7 illustrates an example of a 128-ary rectangular modulation constellation with non-uniform spacing for a lower code rate according to an embodiment of the present disclosure, with the bit-to-symbol mapping for each constellation point shown for reference.

For lower code rates, i.e., scenarios with lower target SNR values, an embodiment of the 128-ary modulation constellation in FIG. 7 is symmetric across all four quadrants and supports Gray code mapping. In this example, four bits can be mapped to one of sixteen in-phase values on the real axis, while three bits can be mapped to one of eight quadrature values on the imaginary axis. In another example, three bits can be mapped to one of eight in-phase values on the real axis, while four bits can be mapped to one of sixteen quadrature values on the imaginary axis. Additional combinations of bits for determining the in-phase and quadrature mappings can be supported.

Given that a total of seven bits are used to determine the symbol mapping in the example in FIG. 7, packing four bits along the real axis requires non-uniform spacing between constellation points in that dimension for an energy-efficient modulation constellation. Also, as the target SNR value decreases, the optimal modulation order in terms of maximizing spectral efficiency decreases. This is equivalent to a 128-ary modulation constellation degenerating into a 64-ary modulation constellation, which is shown to a greater extent by the sixteen clumped pairs of constellation points on either side of the imaginary axis, and to a lesser extent by the other pairs of constellation points (especially as the absolute value of their in-phase component increases). In addition, as fewer bits are packed along the imaginary axis, the spacing between constellation points in that dimension is more uniform.

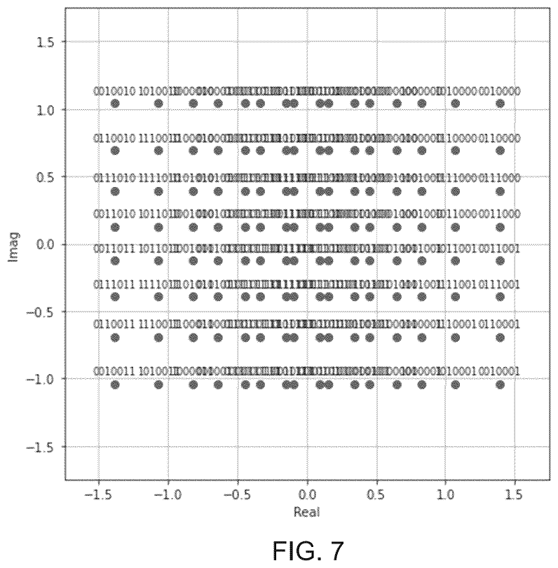

FIG. 8 illustrates an example of a 128-ary rectangular modulation constellation with non-uniform spacing for a higher code rate according to an embodiment of the present disclosure, with the bit-to-symbol mapping for each constellation point shown for reference.

For higher code rates, i.e., scenarios with higher target SNR values, an embodiment of the 128-ary modulation constellation in FIG. 8 is symmetric across all four quadrants and supports Gray mapping. In this example, four bits can be mapped to one of sixteen in-phase values on the real axis, while three bits can be mapped to one of eight quadrature values on the imaginary axis. In another example, three bits can be mapped to one of eight in-phase values on the real axis, while four bits can be mapped to one of sixteen quadrature values on the imaginary axis. Additional combinations of bits for determining the in-phase and quadrature mappings can be supported.

Given that a total of seven bits are used to determine the symbol mapping in the example in FIG. 8, packing four bits along the real axis still requires non-uniform spacing between constellation points in that dimension for an energy-efficient modulation constellation. Since the target SNR value in this example is higher than the example in FIG. 7, though, the spacing between constellation points in the real axis is more uniform in this example. This can be seen in the sixteen pairs of constellation points on either side of the imaginary axis, which are less clumped than those in FIG. 7. Again, as fewer bits are packed along the imaginary axis, the spacing between constellation points in that dimension is more uniform.

### Bit-to-Symbol Mapping

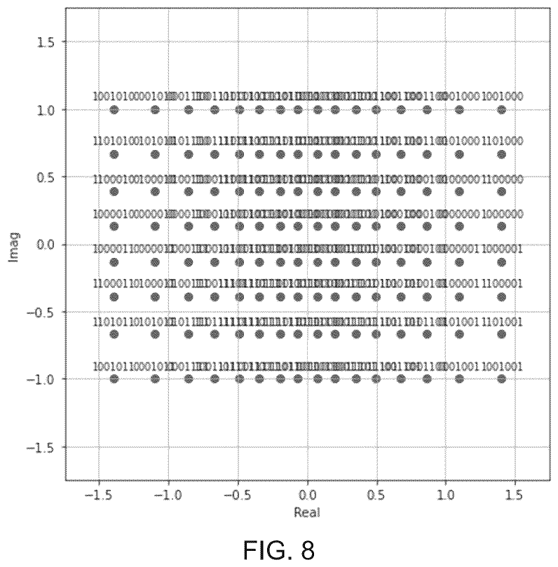

FIG. 9 shows an example of a Gray mapping for a 128-ary rectangular modulation constellation with non-uniform spacing according to an embodiment of the present disclosure, with the bit-to-symbol mapping for the 16 constellation points with the largest absolute value in-phase component shown for reference. The LSB for each bit-to-symbol mapping is in boldface. The fourth MSB for each mapping is underlined, and heavy dashed line partitions are placed at quadrature values of ±0.5.

The eight labeled constellation points above the in-phase axis (which is shown as a heavy solid line) have an LSB of 0, while the eight labeled constellation points below the in-phase axis have an LSB of 1. This simplifies LLR computations for the LSB by utilizing a simple thresholding operation for the in-phase axis, which divides the eight quadrature levels for the constellation into two groups of four levels. Thus, only eight (instead of 128) terms are required for this LLR computation. This simplification extends to computing the LLR for the LSB for all of the constellation points, including the 112 unlabeled points.

The four labeled constellation points above the partition with quadrature value 0.5 have a fourth MSB of 1, and the four labeled constellation points below the partition with quadrature value −0.5 also have a fourth MSB of 1. The eight labeled constellation points between these two partitions have a fourth MSB of 0. Again, this simplifies LLR computations for the fourth MSB by utilizing a simple thresholding operation for these two partitions, which divides the eight quadrature levels for the constellation into two groups of four levels. One group includes the four levels between these two partitions, and the other group includes the remaining four levels. Thus, only eight (instead of 128) terms are required for this LLR computation. This simplification extends to computing the LLR for the fourth MSB for all of the constellation points, including the 112 unlabeled points.

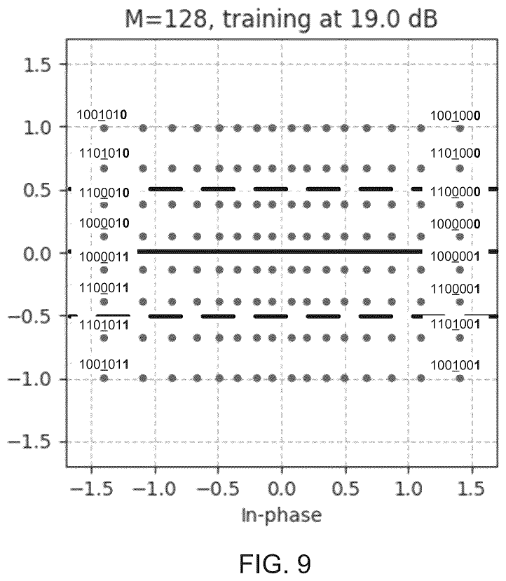

FIG. 10 shows an example of a partition of a 32-ary rectangular modulation constellation with non-uniform spacing in the in-phase direction according to an embodiment of the present disclosure, with the bit-to-symbol mapping for each constellation point shown for reference.

Partitions are shown in heavy dashed lines and correspond to the second MSB, which is denoted b₂. The partitions facilitate a relatively simple LLR computation, since the constellation spacing in the quadrature direction is effectively uniform. Accordingly, to compute LLR for constellation points between the partitions, only four terms may be required, not 32.

As an example, assume that the quadrature values for the constellation points in FIG. 10 are drawn from the set {−3a\sqrt{E_{S}},−a\sqrt{E_{S}},a\sqrt{E_{S}},3a\sqrt{E_{S}},} and that the partitions in heavy dashed lines are placed at quadrature values 2a\sqrt{E_{S}} and −2a\sqrt{E_{S}}. The LLR for the second MSB b₂ corresponds to the following expression:

$$Λ ( {b}_{2} \vert r ) = log \{ \frac{{e}^{- \frac{{( r - 3 a \sqrt{{E}_{s}} )}^{2}}{{N}_{o}}} + {e}^{- \frac{{( r + 3 a \sqrt{{E}_{s}} )}^{2}}{{N}_{o}}}}{{e}^{- \frac{{( r - a \sqrt{{E}_{s}} )}^{2}}{{N}_{o}}} + {e}^{- \frac{{( r + a \sqrt{{E}_{s}} )}^{2}}{{N}_{o}}}} \} , \qquad ( 1 )$$

where r corresponds to the received complex symbol and Nₒ corresponds to the complex noise variance. As in the example in FIG. 9, the partitions simplify the LLR computation in equation (1) by dividing the four quadrature values for this constellation into two groups. One group includes the two levels between these two partitions, and the other group includes the remaining two levels. Thus, only four (instead of 32) terms are required for the LLR computation in equation (1).

After factoring out the quadratic term in r and extracting the quadratic term in a, equation (1) can be simplified as:

$$Λ ( {b}_{2} \vert r ) = - \frac{8 {a}^{2} {E}_{s}}{{N}_{o}} + log \{ \frac{{e}^{\frac{6 a r \sqrt{{E}_{s}}}{{N}_{o}}} + {e}^{\frac{- 6 ar \sqrt{{E}_{s}}}{{N}_{o}}}}{{e}^{\frac{2 a r \sqrt{{E}_{s}}}{{N}_{o}}} + {e}^{\frac{- 2 ar \sqrt{{E}_{s}}}{{N}_{o}}}} \} . \qquad ( 2 )$$

Equation (2) can be simplified given that [5]:

$$log ( {e}^{x} + {e}^{y} ) = {max}^{*} ( x , y ) , \qquad ( 3 )$$

$$where :$$

$${max}^{*} ( x , y ) = max ( x , y ) + log ( 1 + {e}^{- \vert x - y \vert} ) .$$

Based on equation (3), equation (2) can be simplified as:

$$Λ ( {b}_{2} \vert r ) = - \frac{8 {a}^{2} {E}_{s}}{{N}_{o}} + {max}^{*} ( \frac{6 a r \sqrt{{E}_{s}}}{{N}_{o}} , - \frac{6 a r \sqrt{{E}_{s}}}{{N}_{o}} ) - {max}^{*} ( \frac{2 a r \sqrt{{E}_{s}}}{{N}_{o}} , - \frac{2 a r \sqrt{{E}_{s}}}{{N}_{o}} ) , \qquad ( 4 )$$

Equation (4) can be simplified using the following approximation:

$${max}^{*} ( x , y ) \approx max ( x , y ) . \qquad ( 5 )$$

Based on equation (5), equation (4) can be simplified as:

$$Λ ( {b}_{2} \vert r ) \approx - \frac{8 {a}^{2} {E}_{s}}{{N}_{o}} + max ( \frac{6 a r \sqrt{{E}_{s}}}{{N}_{o}} , - \frac{6 a r \sqrt{{E}_{s}}}{{N}_{o}} ) - max ( \frac{2 a r \sqrt{{E}_{s}}}{{N}_{o}} , - \frac{2 a r \sqrt{{E}_{s}}}{{N}_{o}} ) . \qquad ( 6 )$$

Finally, equation (6) reduces to:

$$Λ ( {b}_{2} \vert r ) \approx \{ \begin{matrix}- \frac{8 {a}^{2} {E}_{s}}{{N}_{o}} + \frac{4 ar \sqrt{{E}_{s}}}{{N}_{o}} if r \geq 0 \\ - \frac{8 {a}^{2} {E}_{s}}{{N}_{o}} - \frac{4 ar \sqrt{{E}_{s}}}{{N}_{o}} if r < 0\end{matrix} . \qquad ( 7 )$$

The LLR expression in equation (7) for the second MSB b₂ is a linear function of the received complex symbol r, highlighting the feasibility of LLR computation for rectangular modulation constellations with non-uniform spacing.

TABLE 1 and TABLE 2 below show examples of mappings from 1) a binary string corresponding to an integer in the column labelled “Mapping” to 2) a location in the complex plane (with in-phase and quadrature phase values).

For 32-ary modulation constellations, a binary string of length 5 (i.e., an integer from 0-31) is mapped to a constellation point. For 128-ary modulation constellations, a binary string of length 7 (i.e., an integer from 0-127) is mapped to a constellation point.

TABLE 1 shows an example of the bit-to-symbol mapping for 32-ary rectangular modulation constellations with non-uniform spacing for lower and higher code rates.

TABLE 1
Example of bit-to-symbol mapping for 32-ary modulation
constellations with non-uniform spacing

| Mapping | Lower Code Rate | Higher Code Rate |
|---|---|---|
| 0 | (0.2825 + 0.9500j) | (0.3944 + 0.8692j) |
| 1 | (0.2825 − 0.9500j) | (0.3944 − 0.8692j) |
| 2 | (−0.2825 + 0.9500j) | (−0.3944 + 0.8692j) |
| 3 | (−0.2825 − 0.9500j) | (−0.3944 − 0.8692j) |
| 4 | (0.2341 + 0.9500j) | (0.7644 + 0.8692j) |
| 5 | (0.2341 − 0.9500j) | (0.7644 − 0.8692j) |
| 6 | (−0.2341 + 0.9500j) | (−0.7644 + 0.8692j) |
| 7 | (−0.2341 − 0.9500j) | (−0.7644 − 0.8692j) |
| 8 | (0.2825 + 0.2558j) | (0.3944 + 0.2646j) |
| 9 | (0.2825 − 0.2558j) | (0.3944 − 0.2646j) |
| 10 | (−0.2825 + 0.2558j) | (−0.3944 + 0.2646j) |
| 11 | (−0.2825 − 0.2558j) | (−0.3944 − 0.2646j) |
| 12 | (0.2341 + 0.2558j) | (0.7644 + 0.2646j) |
| 13 | (0.2341 − 0.2558j) | (0.7644 − 0.2646j) |
| 14 | (−0.2341 + 0.2558j) | (−0.7644 + 0.2646j) |
| 15 | (−0.2341 + 0.2558j) | (−0.7644 − 0.2646j) |
| 16 | (0.8370 + 0.9500j) | (0.1571 + 0.8692j) |
| 17 | (0.8370 − 0.9500j) | (0.1571 − 0.8692j) |
| 18 | (−0.8370 + 0.9500j) | (−0.1571 + 0.8692j) |
| 19 | (−0.8370 − 0.9500j) | (−0.1571 − 0.8692j) |
| 20 | (1.1086 + 0.9500j) | (1.2588 + 0.8692j) |
| 21 | (1.1086 − 0.9500j) | (1.2588 − 0.8692j) |
| 22 | (−1.1086 + 0.9500j) | (−1.2588 + 0.8692j) |
| 23 | (−1.1086 − 0.9500j) | (−1.2588 − 0.8692j) |
| 24 | (0.8370 + 0.2558j) | (0.1571 + 0.2646j) |
| 25 | (0.8370 − 0.2558j) | (0.1571 − 0.2646j) |
| 26 | (−0.8370 + 0.2558j) | (−0.1571 + 0.2646j) |
| 27 | (−0.8370 + 0.2558j) | (−0.1571 − 0.2646j) |
| 28 | (1.1086 + 0.2558j) | (1.2588 + 0.2646j) |
| 29 | (1.1086 − 0.2558j) | (1.2588 − 0.2646j) |
| 30 | (−1.1086 + 0.2558j) | (−1.2588 + 0.2646j) |
| 31 | (−1.1086 + 0.2558j) | (−1.2588 − 0.2646j) |

TABLE 2 shows an example of the bit-to-symbol mapping for 128-ary rectangular modulation constellations with non-uniform spacing for lower and higher code rates.

TABLE 2
Example of bit-to-symbol mapping for 128-ary modulation
constellations with non-uniform spacing

| Mapping | Lower Code Rate | Higher Code Rate |
|---|---|---|
| 0 | (0.6444 + 1.0430j) | (1.0982 + 0.1297j) |
| 1 | (0.6444 − 1.0430j) | (1.0982 − 0.1297j) |
| 2 | (−0.6444 + 1.0430j) | (−1.0982 + 0.1297j) |
| 3 | (−0.6444 − 1.0430j) | (−1.0982 − 0.1297j) |
| 4 | (0.4459 + 1.0430j) | (0.8624 + 0.1297j) |
| 5 | (0.4459 − 1.0430j) | (0.8624 − 0.1297j) |
| 6 | (−0.4459 + 1.0430j) | (−0.8624 + 0.1297j) |
| 7 | (−0.4459 − 1.0430j) | (−0.8624 − 0.1297j) |
| 8 | (0.6444 + 0.1263j) | (1.0982 + 0.9986j) |
| 9 | (0.6444 − 0.1263j) | (1.0982 − 0.9986j) |
| 10 | (−0.6444 + 0.1263j) | (−1.0982 + 0.9986j) |
| 11 | (−0.6444 − 0.1263j) | (−1.0982 − 0.9986j) |
| 12 | (0.4459 + 0.1263j) | (0.8624 + 0.9986j) |
| 13 | (0.4459 − 0.1263j) | (0.8624 − 0.9986j) |
| 14 | (−0.4459 + 0.1263j) | (−0.8624 + 0.9986j) |
| 15 | (−0.4459 − 0.1263j) | (−0.8624 − 0.9986j) |
| 16 | (1.3916 + 1.0430j) | (0.1963 + 0.1297j) |
| 17 | (1.3916 − 1.0430j) | (0.1963 − 0.1297j) |
| 18 | (−1.3916 + 1.0430j) | (−0.1963 + 0.1297j) |
| 19 | (−1.3916 − 1.0430j) | (−0.1963 − 0.1297j) |
| 20 | (0.0941 + 1.0430j) | (0.3524 + 0.1297j) |
| 21 | (0.0941 − 1.0430j) | (0.3524 − 0.1297j) |
| 22 | (−0.0941 + 1.0430j) | (−0.3524 + 0.1297j) |
| 23 | (−0.0941 − 1.0430j) | (−0.3524 − 0.1297j) |
| 24 | (1.3916 + 0.1263j) | (0.1963 + 0.9986j) |
| 25 | (1.3916 − 0.1263j) | (0.1963 − 0.9986j) |
| 26 | (−1.3916 + 0.1263j) | (−0.1963 + 0.9986j) |
| 27 | (−1.3916 − 0.1263j) | (−0.1963 − 0.9986j) |
| 28 | (0.0941 + 0.1263j) | (0.3524 + 0.9986j) |
| 29 | (0.0941 − 0.1263j) | (0.3524 − 0.9986j) |
| 30 | (−0.0941 + 0.1263j) | (−0.3524 + 0.9986j) |
| 31 | (−0.0941 − 0.1263j) | (−0.3524 − 0.9986j) |
| 32 | (0.6444 + 0.6916j) | (1.0982 + 0.3896j) |
| 33 | (0.6444 − 0.6916j) | (1.0982 − 0.3896j) |
| 34 | (−0.6444 + 0.6916j) | (−1.0982 + 0.3896j) |
| 35 | (−0.6444 − 0.6916j) | (−1.0982 − 0.3896j) |
| 36 | (0.4459 + 0.6916j) | (0.8624 + 0.3896j) |
| 37 | (0.4459 − 0.6916j) | (0.8624 − 0.3896j) |
| 38 | (−0.4459 + 0.6916j) | (−0.8624 + 0.3896j) |
| 39 | (−0.4459 − 0.6916j) | (−0.8624 − 0.3896j) |
| 40 | (0.6444 + 0.3930j) | (1.0982 + 0.6687j) |
| 41 | (0.6444 − 0.3930j) | (1.0982 − 0.6687j) |
| 42 | (−0.6444 + 0.3930j) | (−1.0982 + 0.6687j) |
| 43 | (−0.6444 − 0.3930j) | (−1.0982 − 0.6687j) |
| 44 | (0.4459 + 0.3930j) | (0.8624 + 0.6687j) |
| 45 | (0.4459 − 0.3930j) | (0.8624 − 0.6687j) |
| 46 | (−0.4459 + 0.3930j) | (−0.8624 + 0.6687j) |
| 47 | (−0.4459 − 0.3930j) | (−0.8624 − 0.6687j) |
| 48 | (1.3916 + 0.6916j) | (0.1963 + 0.3896j) |
| 49 | (1.3916 − 0.6916j) | (0.1963 − 0.3896j) |
| 50 | (−1.3916 + 0.6916j) | (−0.1963 + 0.3896j) |
| 51 | (−1.3916 − 0.6916j) | (−0.1963 − 0.3896j) |
| 52 | (0.0941 + 0.6916j) | (0.3524 + 0.3896j) |
| 53 | (0.0941 − 0.6916j) | (0.3524 − 0.3896j) |
| 54 | (−0.0941 + 0.6916j) | (−0.3524 + 0.3896j) |
| 55 | (−0.0941 − 0.6916j) | (−0.3524 − 0.3896j) |
| 56 | (1.3916 + 0.3930j) | (0.1963 + 0.6687j) |
| 57 | (1.3916 − 0.3930j) | (0.1963 − 0.6687j) |
| 58 | (−1.3916 + 0.3930j) | (−0.1963 + 0.6687j) |
| 59 | (−1.3916 − 0.3930j) | (−0.1963 − 0.6687j) |
| 60 | (0.0941 + 0.3930j) | (0.3524 + 0.6687j) |
| 61 | (0.0941 − 0.3930j) | (0.3524 − 0.6687j) |
| 62 | (−0.0941 + 0.3930j) | (−0.3524 + 0.6687j) |
| 63 | (−0.0941 − 0.3930j) | (−0.3524 − 0.6687j) |
| 64 | (0.8236 + 1.0430j) | (1.4008 + 0.1297j) |
| 65 | (0.8236 − 1.0430j) | (1.4008 − 0.1297j) |
| 66 | (−0.8236 + 1.0430j) | (−1.4008 + 0.1297j) |
| 67 | (−0.8236 − 1.0430j) | (−1.4008 − 0.1297j) |
| 68 | (0.3436 + 1.0430j) | (0.6694 + 0.1297j) |
| 69 | (0.3436 − 1.0430j) | (0.6694 − 0.1297j) |
| 70 | (−0.3436 + 1.0430j) | (−0.6694 + 0.1297j) |
| 71 | (−0.3436 + 1.0430j) | (−0.6694 − 0.1297j) |
| 72 | (0.8236 + 0.1263j) | (1.4008 + 0.9986j) |
| 73 | (0.8236 − 0.1263j) | (1.4008 − 0.9986j) |
| 74 | (−0.8236 + 0.1263j) | (−1.4008 + 0.9986j) |
| 75 | (−0.8236 − 0.1263j) | (−1.4008 − 0.9986j) |
| 76 | (0.3436 + 0.1263j) | (0.6694 + 0.9986j) |
| 77 | (0.3436 − 0.1263j) | (0.6694 − 0.9986j) |
| 78 | (−0.3436 + 0.1263j) | (−0.6694 + 0.9986j) |
| 79 | (−0.3436 − 0.1263j) | (−0.6694 − 0.9986j) |
| 80 | (1.0714 + 1.0430j) | (0.0744 + 0.1297j) |
| 81 | (1.0714 − 1.0430j) | (0.0744 − 0.1297j) |
| 82 | (−1.0714 + 1.0430j) | (−0.0744 + 0.1297j) |
| 83 | (−1.0714 − 1.0430j) | (−0.0744 − 0.1297j) |
| 84 | (0.1528 + 1.0430j) | (0.4957 + 0.1297j) |
| 85 | (0.1528 − 1.0430j) | (0.4957 − 0.1297j) |
| 86 | (−0.1528 + 1.0430j) | (−0.4957 + 0.1297j) |
| 87 | (−0.1528 − 1.0430j) | (−0.4957 − 0.1297j) |
| 88 | (1.0714 + 0.1263j) | (0.0744 + 0.9986j) |
| 89 | (1.0714 − 0.1263j) | (0.0744 − 0.9986j) |
| 90 | (−1.0714 + 0.1263j) | (−0.0744 + 0.9986j) |
| 91 | (−1.0714 − 0.1263j) | (−0.0744 − 0.9986j) |
| 92 | (0.1528 + 0.1263j) | (0.4957 + 0.9986j) |
| 93 | (0.1528 − 0.1263j) | (0.4957 − 0.9986j) |
| 94 | (−0.1528 + 0.1263j) | (−0.4957 + 0.9986j) |
| 95 | (−0.1528 − 0.1263j) | (−0.4957 − 0.9986j) |
| 96 | (0.8236 + 0.6916j) | (1.4008 + 0.3896j) |
| 97 | (0.8236 − 0.6916j) | (1.4008 − 0.3896j) |
| 98 | (−0.8236 + 0.6916j) | (−1.4008 + 0.3896j) |
| 99 | (−0.8236 − 0.6916j) | (−1.4008 − 0.3896j) |
| 100 | (0.3436 + 0.6916j) | (0.6694 + 0.3896j) |
| 101 | (0.3436 − 0.6916j) | (0.6694 − 0.3896j) |
| 102 | (−0.3436 + 0.6916j) | (−0.6694 + 0.3896j) |
| 103 | (−0.3436 − 0.6916j) | (−0.6694 − 0.3896j) |
| 104 | (0.8236 + 0.3930j) | (1.4008 + 0.6687j) |
| 105 | (0.8236 − 0.3930j) | (1.4008 − 0.6687j) |
| 106 | (−0.8236 + 0.3930j) | (−1.4008 + 0.6687j) |
| 107 | (−0.8236 − 0.3930j) | (−1.4008 − 0.6687j) |
| 108 | (0.3436 + 0.3930j) | (0.6694 + 0.6687j) |
| 109 | (0.3436 − 0.3930j) | (0.6694 − 0.6687j) |
| 110 | (−0.3436 + 0.3930j) | (−0.6694 + 0.6687j) |
| 111 | (−0.3436 − 0.3930j) | (−0.6694 − 0.6687j) |
| 112 | (1.0714 + 0.6916j) | (0.0744 + 0.3896j) |
| 113 | (1.0714 − 0.6916j) | (0.0744 − 0.3896j) |
| 114 | (−1.0714 + 0.6916j) | (−0.0744 + 0.3896j) |
| 115 | (−1.0714 − 0.6916j) | (−0.0744 − 0.3896j) |
| 116 | (0.1528 + 0.6916j) | (0.4957 + 0.3896j) |
| 117 | (0.1528 − 0.6916j) | (0.4957 − 0.3896j) |
| 118 | (−0.1528 + 0.6916j) | (−0.4957 + 0.3896j) |
| 119 | (−0.1528 + 0.6916j) | (−0.4957 − 0.3896j) |
| 120 | (1.0714 + 0.3930j) | (0.0744 + 0.6687j) |
| 121 | (1.0714 − 0.3930j) | (0.0744 − 0.6687j) |
| 122 | (−1.0714 + 0.3930j) | (−0.0744 + 0.6687j) |
| 123 | (−1.0714 − 0.3930j) | (−0.0744 − 0.6687j) |
| 124 | (0.1528 + 0.3930j) | (0.4957 + 0.6687j) |
| 125 | (0.1528 − 0.3930j) | (0.4957 − 0.6687j) |
| 126 | (−0.1528 + 0.3930j) | (−0.4957 + 0.6687j) |
| 127 | (−0.1528 − 0.3930j) | (−0.4957 − 0.6687j) |

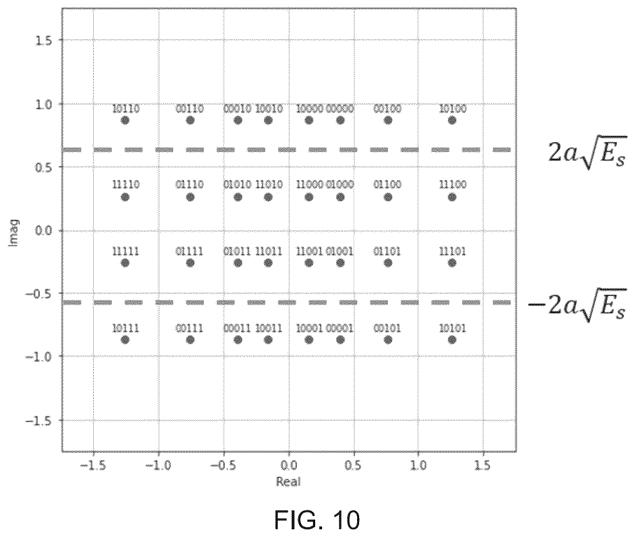

FIG. 11 is an example of the BLER performance of several rectangular modulation constellations with non-uniform spacing over an AWGN channel. In this case, the information block size and the number of modulation symbols were fixed at 2666 and 500, respectively, for all modulation constellations. Two 128-ary modulation constellations (trace 1101 and trace 1103) and two 256-ary modulation constellations (trace 1102 and trace 1104) were obtained via AI/ML training at certain target energy per symbol to noise power spectral density ratio (Es/No) values. All four of these modulation constellations with non-uniform spacing outperform a conventional 256-QAM constellation (i.e., the trace labeled 1105) by at least 0.5 dB at a target BLER of 0.1. Also, the 128-ary modulation constellation that has been obtained via AI/ML training at a target Es/No of 20 dB (i.e., trace 1101) outperforms the other three modulation constellations with non-uniform spacing by about 0.05 dB at a target BLER of 0.1. These results demonstrate 1) the connection between non-uniform spacing between constellation points and compensation for shaping loss and 2) the benefits of using rectangular modulation constellations where the modulation order is not a power of 4.

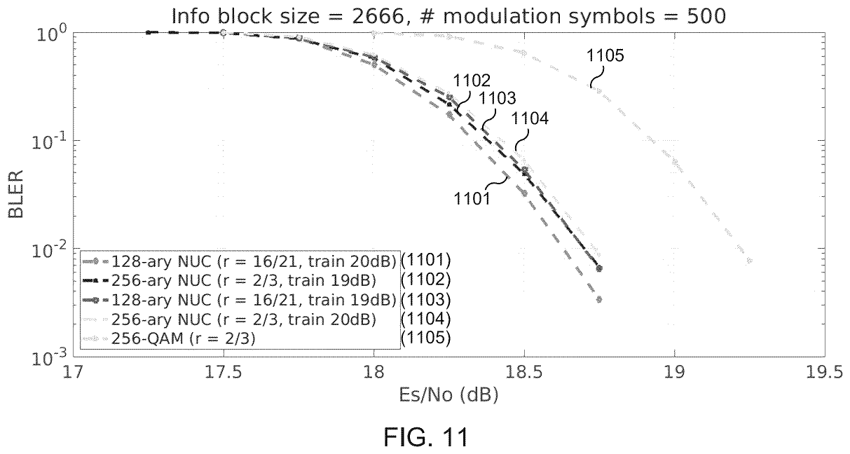

FIG. 12 is an example of the BLER performance of various 128-ary modulation constellations over an AWGN channel. In this case, the information block size and the number of modulation symbols were fixed at 2666 and 500, respectively, for all modulation constellations. The two 128-ary modulation constellations (trace 1101 and trace 1102) from FIG. 11 were considered here, along with 1) a cross-shaped 128-QAM modulation constellation (trace 1203) that supports Gray code mapping and 2) a rectangular 128-QAM modulation constellation (trace 1204) with uniform spacing that also supports Gray code mapping. Both of the 128-ary modulation constellations from FIG. 11 outperform the cross-shaped and rectangular 128-QAM modulation constellations by 0.1 dB and 1 dB at a target BLER of 0.1, respectively. Again, these results demonstrate the connection between non-uniform spacing between constellation points and compensation for shaping loss.

### Configuration Method

Configuration to support mapping between MCS index and rectangular modulation constellation with non-uniform spacing is considered.

In one embodiment, a UE can use an MCS index to determine a rectangular modulation constellation with non-uniform spacing. TABLE 3 is an example of modifying a lookup table to facilitate this approach. In this example, each MCS index maps to a modulation order, a target code rate, a spectral efficiency, and an identifier (ID) of a modulation constellation. This modulation constellation includes a set of points (e.g., 32 points if the modulation order is 5). A UE can use the target code rate for encoding information bits, and the encoded bits can be modulated according to the points in the modulation constellation.

TABLE 3
An example of a modified lookup table to support
a mapping between MCS indices and rectangular modulation
constellations with non-uniform spacing

| | | Target | | |
|---|---|---|---|---|
| | | Code Rate | | |
| MCS | Modulation | R × | Spectral | |
| Index | Order | [1024] | Efficiency | Constellation ID |
| . . . | . . . | . . . | . . . | . . . |
| 10 | 5 | 658 | 2.5703 | 32ary_5 dB_const_1 |
| . . . | . . . | . . . | . . . | . . . |
| 15 | 6 | 666 | 3.9023 | 64ary_13 dB_const_3 |
| . . . | . . . | . . . | . . . | . . . |
| 20 | 7 | 682.5 | 5.332 | 128ary_18 dB_const_5 |
| . . . | . . . | . . . | . . . | . . . |

TABLE 4 is another example of modifying a lookup table to facilitate a determination of a rectangular modulation constellation with non-uniform spacing. In this example, each MCS index maps to a set of 8 “base points”, which all lie in the first quadrant of the complex plane. Quadrant symmetry is assumed in this example, and so these “base points” can be reflected across the real and imaginary axes, along with the origin, to obtain all 32 points of the corresponding 32-ary modulation constellation. This example can be extended to support modulation orders other than 32.

TABLE 4
An example of a modified lookup table that incorporates quadrant symmetry

| MCS | Base | Base | Base | Base | Base | Base | Base | Base |
|---|---|---|---|---|---|---|---|---|
| Index | Point #1 | Point #2 | Point #3 | Point #4 | Point #5 | Point #6 | Point #7 | Point #8 |
| . . . | . . . | . . . | . . . | . . . | . . . | . . . | . . . | . . . |
| 10 | (0.4, 0.4) | (0.6, 0.4) | (1.0, 0.4) | (1.2, 0.4) | (0.4, 0.8) | (0.6, 0.8) | (1.0, 0.8) | (1.2, 0.8) |
| 11 | (0.4, 0.4) | (0.5, 0.4) | (1.1, 0.4) | (1.2, 0.4) | (0.4, 0.8) | (0.5, 0.8) | (1.1, 0.8) | (1.2, 0.8) |
| 12 | (0.2, 0.4) | (0.4, 0.4) | (1.0, 0.4) | (1.2, 0.4) | (0.2, 0.6) | (0.4, 0.6) | (1.0, 0.6) | (1.2, 0.6) |
| . . . | . . . | . . . | . . . | . . . | . . . | . . . | . . . | . . . |

TABLE 5 is another example of modifying a lookup table to facilitate a determination of a rectangular modulation constellation with non-uniform spacing. In this example, each MCS index maps to a set of 16 “original points,” which all lie in the first quadrant of the complex plane. These “original points” correspond to a conventional constellation with uniform spacing. The real and imaginary parts of each of these “original points” are then shifted by a specified amount. Quadrant symmetry is assumed in this example, and so these shifted “original points” can be reflected across the real and imaginary axes, along with the origin, to obtain all 64 points of the corresponding 64-ary modulation constellation. This example can be extended to support modulation orders other than 64.

TABLE 5
An example of a modified lookup table that incorporates
adjustments to conventional constellation points

| MCS | Original | Re/Im | Original | Re/Im | | Original | Re/Im |
|---|---|---|---|---|---|---|---|
| Index | Point #1 | Shift #1 | Point #2 | Shift #2 | . . . | Point #16 | Shift #16 |
| . . . | . . . | . . . | . . . | . . . | . . . | . . . | . . . |
| 10 | (0.4, 0.4) | (0.05, −0.05) | (0.6, 0.4) | (−0.05, −0.05) | . . . | (1.0, 0.8) | (−0.01, 0.01) |
| 11 | (0.4, 0.4) | (0.02, −0.02) | (0.6, 0.4) | (−0.03, −0.03) | . . . | (1.0, 0.8) | (−0.05, 0.05) |
| 12 | (0.4, 0.4) | (−0.05, 0.05) | (0.6, 0.4) | (0.07, −0.03) | . . . | (1.0, 0.8) | (0.04, −0.02) |
| . . . | . . . | . . . | . . . | . . . | . . . | . . . | . . . |

Examples of bit-to-symbol mapping formulas are considered.

An example of a bit-to-symbol mapping for a 32-ary modulation constellation is shown below:

$$d ( i ) = \frac{1}{\sqrt{A}} \{ ( {B}_{1} - {C}_{1} b ( 5 i ) ) [ {B}_{2} - ( {B}_{3} - {C}_{2} b ( 5 i + 2 ) ) [ {B}_{4} - ( {B}_{5} - {C}_{3} b ( 5 i + 4 ) ) ] ] + j ( {B}_{6} - {C}_{4} b ( 5 i + 1 ) ) [ {B}_{7} - ( {B}_{8} - {C}_{5} b ( 5 i + 3 ) ) ] \} .$$

In this example, a pentuplet of bits, b(5i), b(5i+1), b(5i+2), b(5i+3), b(5i+4), are mapped to complex-valued modulation symbols d(i). The values of the coefficients B₁, B₂, . . . , B₈, C₁, C₂, . . . , C₅ can either be specified or configured by a BS.

Another example of a bit-to-symbol mapping for a 32-ary modulation constellation is shown below:

$$d ( i ) = \frac{1}{\sqrt{A}} \{ ( {B}_{1} + {B}_{2} b ( 5 i ) + {B}_{3} b ( 5 i + 2 ) + {B}_{4} b ( 5 i + 4 ) + {B}_{5} b ( 5 i ) b ( 5 i + 2 ) + {B}_{6} b ( 5 i ) b ( 5 i + 4 ) + {B}_{7} b ( 5 i + 2 ) b ( 5 i + 4 ) + {B}_{8} b ( 5 i ) b ( 5 i + 2 ) b ( 5 i + 4 ) ) + j ( {C}_{1} + {C}_{2} b ( 5 i + 1 ) + {C}_{3} b ( 5 i + 3 ) + {C}_{4} b ( 5 i + 1 ) b ( 5 i + 3 ) ) \} .$$

In this example, a pentuplet of bits, b(5i), b(5i+1), b(5i+2), b(5i+3), b(5i+4), are again mapped to complex-valued modulation symbols d(i). The values of the coefficients B₁, B₂, . . . , B₈, C₁, C₂, . . . , C₄ can either be specified or configured by a BS.

An example of a bit-to-symbol mapping for a 128-ary modulation constellation is shown below:

$$d ( i ) = \frac{1}{\sqrt{A}} \{ ( {B}_{1} - {C}_{1} b ( 7 i ) ) [ {B}_{2} - ( {B}_{3} - {C}_{2} b ( 7 i + 2 ) ) [ {B}_{4} - ( {B}_{5} - {C}_{3} b ( 7 i + 4 ) ) [ {B}_{6} - ( {B}_{7} - {C}_{4} b ( 7 i + 6 ) ) ] ] ] + j ( {B}_{8} - {C}_{5} b ( 7 i + 1 ) ) [ {B}_{9} - ( {B}_{10} - {C}_{6} b ( 7 i + 3 ) ) [ {B}_{11} - ( {B}_{12} - {C}_{7} b ( 7 i + 5 ) ) ] ] \} .$$

In this example, a septuplet of bits, b(7i), b(7i+1), b(7i+2), b(7i+3), b(7i+4), b(7i+5), b(7i+6), are mapped to complex-valued modulation symbols d(i). The values of the coefficients B₁, B₂, . . . , B₁₂, C₁, C₂, . . . , C₇ can either be specified or configured by a BS.

Another example of a bit-to-symbol mapping for a 128-ary modulation constellation is shown below:

$$d ( i ) = \frac{1}{\sqrt{A}} \{ ( {B}_{1} + {B}_{2} b ( 7 i ) + {B}_{3} b ( 7 i + 2 ) + {B}_{4} b ( 7 i + 4 ) + {B}_{5} b ( 7 i + 6 ) + {B}_{6} b ( 7 i ) b ( 7 i + 2 ) + {B}_{7} b ( 7 i ) b ( 7 i + 4 ) + {B}_{8} b ( 7 i ) b ( 7 i + 6 ) + {B}_{9} b ( 7 i + 2 ) b ( 7 i + 4 ) + {B}_{10} b ( 7 i + 2 ) b ( 7 i + 6 ) + {B}_{11} b ( 7 i + 4 ) b ( 7 i + 6 ) + {B}_{12} b ( 7 i ) b ( 7 i + 2 ) b ( 7 i + 4 ) + {B}_{13} b ( 7 i ) b ( 7 i + 2 ) b ( 7 i + 6 ) + {B}_{14} b ( 7 i ) b ( 7 i + 4 ) b ( 7 i + 6 ) + {B}_{15} b ( 7 i + 2 ) b ( 7 i + 4 ) b ( 7 i + 6 ) + {B}_{16} b ( 7 i ) b ( 7 i + 2 ) b ( 7 i + 4 ) b ( 7 i + 6 ) ) + ( {C}_{1} + {C}_{2} b ( 7 i + 1 ) + {C}_{3} b ( 7 i + 3 ) + {C}_{4} b ( 7 i + 5 ) + {C}_{5} b ( 7 i + 1 ) b ( 7 i + 3 ) + {C}_{6} b ( 7 i + 1 ) b ( 7 i + 5 ) + {C}_{7} b ( 7 i + 3 ) b ( 7 i + 5 ) + {C}_{8} b ( 7 i + 1 ) b ( 7 i + 3 ) b ( 7 i + 5 ) ) \} .$$

In this example, a septuplet of bits, b(7i), b(7i+1), b(7i+2), b(7i+3), b(7i+4), b(7i+5), b(7i+6), are again mapped to complex-valued modulation symbols d(i). The values of the coefficients B₁, B₂, . . . , B₁₆, C₁, C₂, . . . , C₈ can either be specified or configured by a BS.

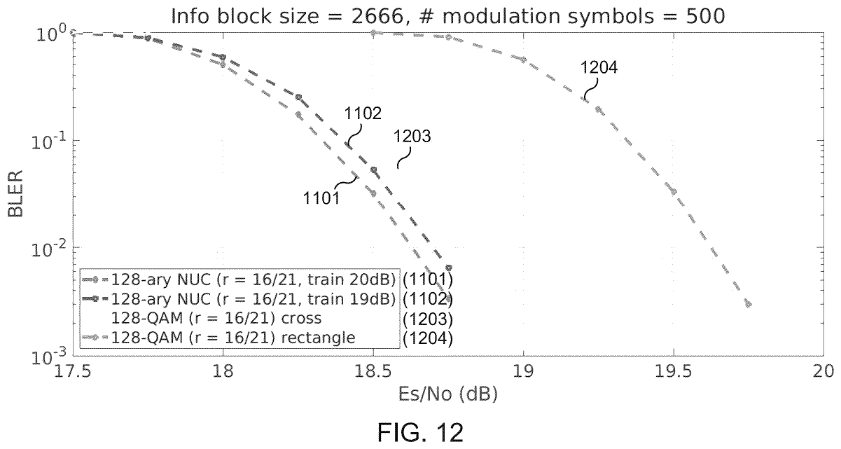

FIG. 13 is a flow diagram illustrating an example of UE operation to support rectangular non-uniform modulation constellations according to an embodiment of the present disclosure.

FIG. 13 is an example of a method 1300 for operations at a UE to support rectangular non-uniform modulation constellations. At operation 1301, a UE sends capability information to a BS, including the support (if any) by the UE for rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M≠32 and M≠128.

At operation 1302, a UE receives rectangular non-uniform constellation configuration information from a BS, which can include information such as enabling/disabling of the mapping between an MCS index and a rectangular non-uniform modulation constellation. Examples of configuration information are described below.

At operation 1303, a UE receives an MCS indication message from a BS for a rectangular non-uniform modulation constellation. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 1304, a UE sends modulation symbols to a BS, which may have been selected from the rectangular non-uniform modulation constellation corresponding to the MCS index.

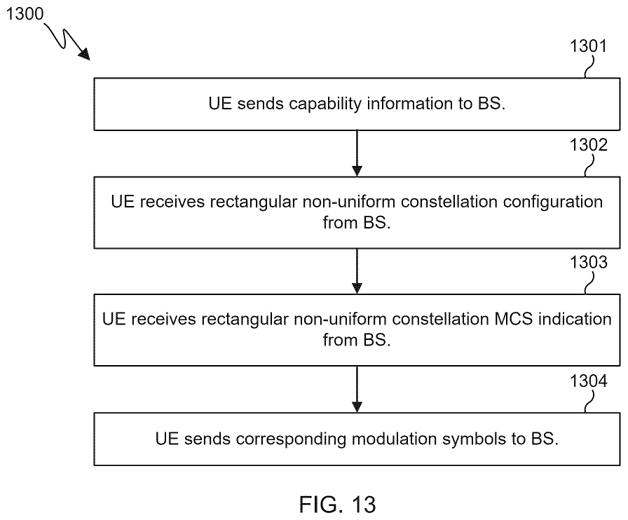

FIG. 14 is a flow diagram illustrating an example of BS operation to support rectangular non-uniform modulation constellations according to an embodiment of the present disclosure.

FIG. 14 is an example of a method 1400 for operations at a BS to support rectangular non-uniform modulation constellations. At operation 1401, a BS receives capability information from a UE, including the support of rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M 32 and M 128.

At operation 1402, a BS sends rectangular non-uniform constellation configuration information to a UE, which can include information such as enabling/disabling of the mapping between an MCS index and a rectangular non-uniform modulation constellation. Examples of configuration information are described below.

At operation 1403, a BS sends an MCS indication message to a UE for a rectangular non-uniform modulation constellation. A BS can use an existing DCI format for this MCS indication message; it can also define a new DCI format for this MCS indication message. In one example, a UE uses this MCS indication message to determine an MCS index. In another example, a UE may autonomously determine an MCS index.

At operation 1404, a BS receives modulation symbols from a UE, which may have been selected from the rectangular non-uniform modulation constellation corresponding to the MCS index.

### Configuration Method

Signaling to send an indication of supported rectangular non-uniform modulation constellations as described in connection with operation 1301 of FIG. 13 and operation 1401 of FIG. 14 is considered.

In one embodiment, a UE can indicate its support for rectangular non-uniform modulation constellations. TABLE 6 is an example of modifying the ModulationOrder information element (IE) to indicate all of the modulation constellations that a UE can support. In this example, NumModMethods corresponds to the total number of modulation constellations, and the “1” values in this bit string correspond to the modulation constellations that this UE can support. TABLE 6 also shows an example of defining a new NUCModulationOrder IE, which is a list of IDs corresponding to rectangular non-uniform modulation constellations.

TABLE 6
An example of IE ModulationOrder modification to indicate
rectangular non-uniform modulation constellations in
addition to conventional modulation constellations

ModulationOrder ::= BIT STRING {SIZE (NumModMethods)}
NUCModulationOrder ::= ENUMERATED {32ary_8dB_const21,
32ary_llp5dB_constO, 128ary_l8dB_const5, 128ary_l9dB_const53}

In another example, for a given modulation order, multiple distinct modulation constellations, including rectangular non-uniform modulation constellations, can be configured.

In one embodiment, a BS can configure a UE to send an indication of its supported rectangular non-uniform modulation constellations via MAC CE activation command.

In one embodiment, a BS can configure a UE to send an indication of its supported rectangular non-uniform modulation constellations via DCI.

Configuration to support rectangular non-uniform modulation constellations is considered.

In one embodiment, a BS can configure a UE to support rectangular non-uniform modulation constellations. TABLE 7 is an example of modifying the PUSCH-Config IE to configure all of the rectangular non-uniform modulation constellations that a UE can support.

TABLE 7
An example of IE PUSCH-Config modification to configure support
of rectangular non-uniform modulation constellations

PUSCH-Config ::= SEQUENCE {

| | |
|---|---|
| dataScramblingIdentityPUSCH | INTEGER (0 .. 1023) |

```
  OPTIONAL, -- Need S
  ...,
```

| | |
|---|---|
| mcs-Table | ENUMERATED {qam256, |

qam64LowSE, qam256NUC) OPTIONAL, -- Need S

| | |
|---|---|
| NUCBit2SymMap-Table | ENUMERATED {table1, table2, |
| | table3) |

OPTIONAL, -- Need S
}

In this example, the mcs-Table field is modified to include a gam256NUC option, which can be an MCS table that includes rectangular non-uniform modulation constellations. Also, NUCBit2SymMap-Table corresponds to a table of bit-to-symbol mappings for rectangular non-uniform modulation constellations, where examples of these mappings can be found in the examples of bit-to-symbol mapping formulas above, following TABLE 5.

TABLE 8 is another example of modifying the PUSCH-Config IE to configure all of the rectangular non-uniform modulation constellations that a UE can support.

TABLE 8
An example of IE PUSCH-Config modification to configure support
of rectangular non-uniform modulation constellations

PUSCH-Config ::= SEQUENCE {

| | |
|---|---|
| dataScramblingIdentityPUSCH | INTEGER (0 .. 1023) |

```
  OPTIONAL, -- Need S
  ...,
```

| | |
|---|---|
| NUCTx | ENUMERATED {enabled, disabled} |
| OPTIONAL, -- Need S | |
| constellationID-NUCTx | INTEGER (1 . . |
| | numConstellationsNUCTx) |

OPTIONAL, -- Need S

| | |
|---|---|
| NUCBit2SymMapcoefs | SEQUENCE { |
| AVal | INTEGER (1 .. maxAVal) |
| BVal1 | INTEGER (minBVal . . maxBVal) |
| BVal2 | INTEGER (minBVal . . maxBVal) |
| CVal1 | INTEGER (minCVal . . maxCVal) |
| Cval2 | INTEGER (minCVal . . maxCVal) |

},
}

In this example, NUCTx corresponds to a flag that indicates whether or not rectangular non-uniform modulation constellations are enabled. constellationID-NUCTx corresponds to an index to a pre-defined table of rectangular non-uniform modulation constellations. NucBit2SymMapCoefs corresponds to a set of coefficients for bit-to-symbol mappings for rectangular non-uniform modulation constellations, where examples of these mappings can be found in the examples of bit-to-symbol mapping formulas above, following TABLE 5.

In another embodiment, a BS can configure a UE to enable switching between rectangular non-uniform modulation constellations. TABLE 9 is another example of modifying the PUSCH-Config IE to configure switching between rectangular non-uniform modulation constellations.

TABLE 9
An example of IE PUSCH-Config modification to configure switching
between rectangular non-uniform modulation constellations

PUSCH-Config ::= SEQUENCE {

| | |
|---|---|
| dataScramblingIdentityPUSCH | INTEGER (0 .. 1023) OPTIONAL, -- |

```
  Need S
  ...,
```

| | |
|---|---|
| NUConfigType | CHOICE { |
| periodic | SEQUENCE { |
| NUCList | SEQUENCE (SIZE (1 .. |

```
      maxNrofNUCs)) OF NUCPerConfig
    },
```

| | |
|---|---|
| semiPersistentOnPUSCH | SEQUENCE (SIZE (1 .. |

```
      maxNrofNUCs)) OF NUCSPSConfig
    },
  },
}
```

NUCConfigType corresponds to configuring switching between rectangular non-uniform modulation constellations as periodic or semi-persistent. In this example, NUCPerConfig corresponds to configuring the slot periodicity and offset for each corresponding modulation constellation in NUCList. Also, NUCSPSConfig corresponds to configuring the slot offset for each corresponding modulation constellation in NUCList.

TABLE 10 is an example of modifying a DCI format to configure all of the rectangular non-uniform modulation constellations that a ULE can support. In this example, one bit is used to indicate whether rectangular non-uniform modulation constellations are configured. Also, four bits are used to indicate a rectangular non-uniform modulation constellation.

TABLE 10
An example of a modified DCI format (including references) to configure
support of rectangular non-uniform modulation constellations

| Field (Item) | Bits | Reference |
|---|---|---|
| Identifier | 1 | |
| for DCI formats | | |
| . . . | | |
| NUC Tx indicator | 1 | Whether NUC Tx is configured or not |
| Constellation | 4 | Define constellation lookup table |
| for NUC Tx | | with 2\hat{ }(#bits) entries |
| UL-SCH indicator | 1 | 0: UL-SCH not transmitted in PUSCH |
| | | 1: UL-SCH transmitted in PUSCH |

In FIGS. 13 and 14, a UE sends capability information regarding rectangular non-uniform modulation constellations to a BS, and a BS can use that information to determine whether or not to send an MCS indication message for a rectangular non-uniform modulation constellation to a UE. An alternative to the approach in FIGS. 13 and 14 entails a UE sending additional information to a BS to assist it in making that determination. In this alternative approach, the UE conveys information that may or may not already be available to a BS.

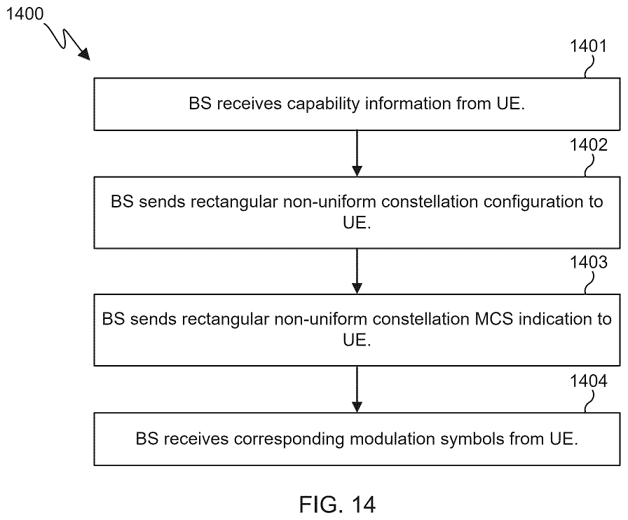

FIG. 15 is a flow diagram illustrating UE operation to support BS determination of MCS indication for rectangular non-uniform modulation constellation according to an embodiment of the present disclosure.

FIG. 15 is an example of a method 1500 for operations at a UE to support BS determination of an MCS indication for a rectangular non-uniform modulation constellation. At operation 1501, a UE sends capability information to a BS, including the support of rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M≠32 and M≠128.

At operation 1502, a UE receives rectangular non-uniform constellation configuration information from a BS, which can include information such as enabling/disabling of the mapping between an MCS index and a rectangular non-uniform modulation constellation.

At operation 1503, a UE receives an MCS indication message from a BS for a conventional transmission method. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 1504, a UE sends modulation symbols to a BS, which may have been selected from the constellation corresponding to the MCS index.

At operation 1505, a UE sends assistance information to a BS; the assistance information will be described in the “UE assistance information” section and can be used by a BS to determine an MCS indication.

At operation 1506, a UE receives an MCS indication message from a BS for a rectangular non-uniform modulation constellation. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 1507, a UE sends modulation symbols to a BS, which may have been selected from the rectangular non-uniform modulation constellation corresponding to the MCS index.

In another example, a BS can pre-determine/configure information about the switching time to a rectangular non-uniform modulation constellation. In this case, operations 1505 and 1506 may be skipped; a UE can send modulation symbols from a rectangular non-uniform modulation constellation to a BS at a pre-determined/configured time in operation 1507.

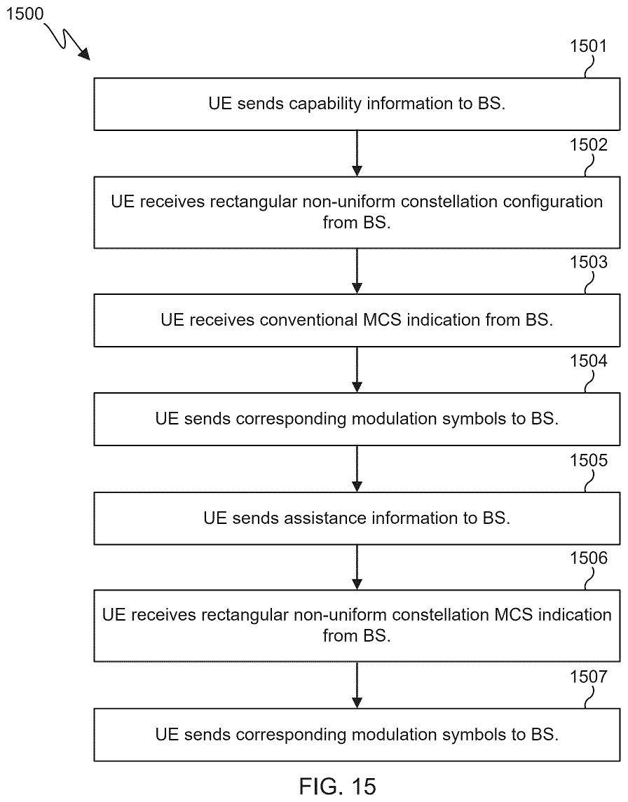

FIG. 16 is a flow diagram illustrating an example of BS operation to support BS determination of MCS indication for rectangular non-uniform modulation constellation according to an embodiment of the present disclosure.

FIG. 16 is an example of a method 1600 for operations at a BS to support BS determination of an MCS indication for a rectangular non-uniform modulation constellation. At operation 1601, a BS receives capability information from a UE, including the support of rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M≠32 and M≠128.

At operation 1602, a BS sends rectangular non-uniform constellation configuration information to a UE, which can include information such as enabling/disabling of the mapping between an MCS index and a rectangular non-uniform modulation constellation. At operation 1603, a BS sends an MCS indication message to a UE for a conventional transmission method. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 1604, a BS receives modulation symbols from a UE, which may have been selected from the constellation corresponding to the MCS index.

At operation 1605, a BS receives assistance information from a UE; the assistance information will be described in the “UE assistance information” section and can be used by a BS to determine an MCS indication.

At operation 1606, a BS sends an MCS indication message to a UE for a rectangular non-uniform modulation constellation. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 1607, a BS receives modulation symbols from a UE, which may have been selected from the rectangular non-uniform modulation constellation corresponding to the MCS index.

In another example, a BS can pre-determine/configure information about the switching time to a rectangular non-uniform modulation constellation. In this case, operations 1605 and 1606 may be skipped; a BS can receive modulation symbols from a rectangular non-uniform modulation constellation from a UE at a pre-determined/configured time in operation 1607.

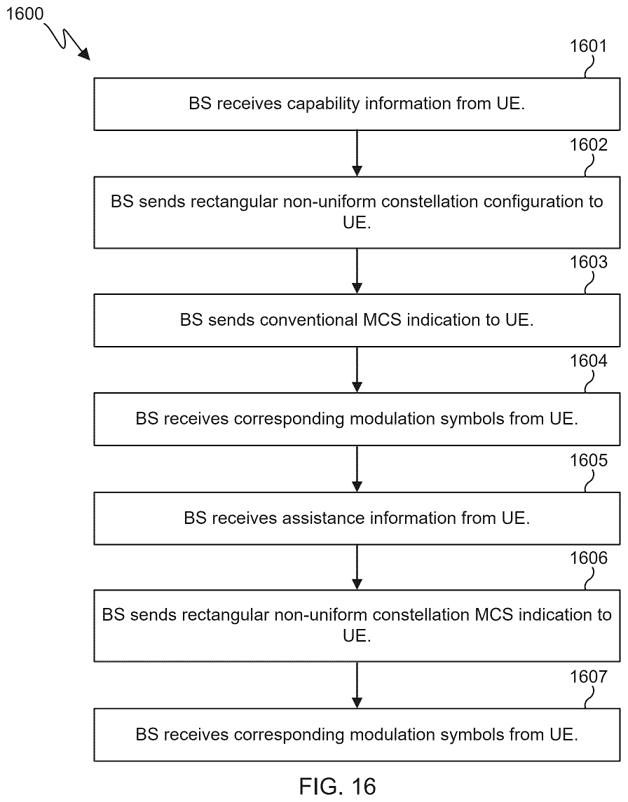

FIG. 17 is a flow diagram illustrating an example of UE operation to support BS configuration of MCS indication for rectangular non-uniform modulation constellation according to an embodiment of the present disclosure.

FIG. 17 is an example of a method 1700 for operations at a UE to support BS configuration of an MCS indication for rectangular non-uniform modulation constellation. At operation 1701, a UE sends its capability information to a BS, including the support of rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M≠32 and M≠128.

At operation 1702, a UE receives rectangular non-uniform constellation configuration information from a BS, which can include information such as enabling/disabling of the mapping between an MCS index and a rectangular non-uniform modulation constellation.

At operation 1703, a UE receives an MCS indication message from a BS for a conventional transmission method. A BS can use an existing DCI format for this MCS indication message. The BS can also define a new DCI format for this MCS indication message. In one example, a UE uses this MCS indication message to determine an MCS index. In another example, a UE may autonomously determine an MCS index. At operation 1704, a UE sends modulation symbols to a BS, which may have been selected from the constellation corresponding to the MCS index.

At operation 1705, a UE receives an MCS indication message from a BS for a rectangular non-uniform modulation constellation. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 1706, a UE sends modulation symbols to a BS, which may have been selected from the rectangular non-uniform modulation constellation corresponding to the MCS index.

In another example, a BS can pre-determine/configure information about the switching time to a rectangular non-uniform modulation constellation. In this case, operation 1705 may be skipped; a UE can send modulation symbols from a rectangular non-uniform modulation constellation to a BS at a pre-determined/configured time in operation 1706.

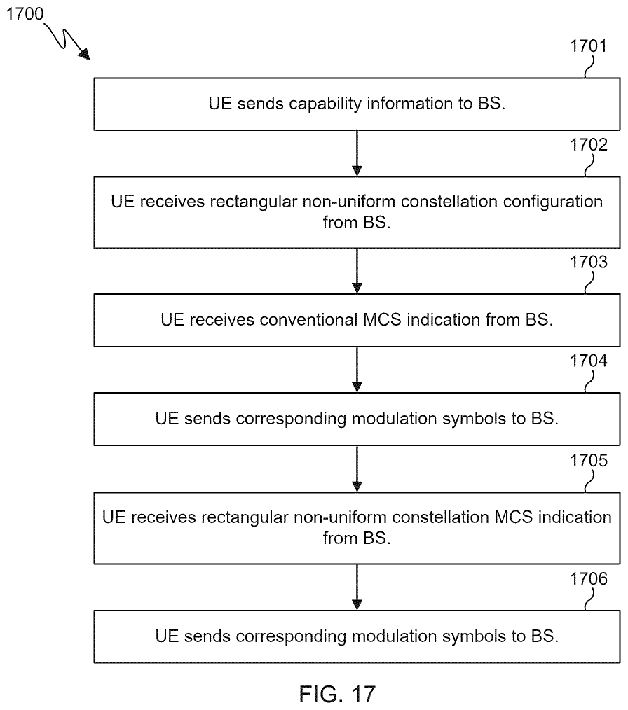

FIG. 18 is a flow diagram illustrating an example of BS operation to support BS configuration of MCS indication for rectangular non-uniform modulation constellation according to an embodiment of the present disclosure.

FIG. 18 is an example of a method 1800 for operations at a BS to support BS configuration of an MCS indication for rectangular non-uniform modulation constellation. At operation 1801, a BS receives capability information from a UE, including the support of rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M≠32 and M≠128.

At operation 1802, a BS sends rectangular non-uniform constellation configuration information to a UE, which can include information such as enabling/disabling of the mapping between an MCS index and a rectangular non-uniform modulation constellation.

At operation 1803, a BS sends an MCS indication message to a UE for a conventional transmission method. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 1804, a BS receives modulation symbols from a UE, which may have been selected from the constellation corresponding to the MCS index.

At operation 1805, a BS sends an MCS indication message to a UE for a rectangular non-uniform modulation constellation. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 1806, a BS receives modulation symbols from a UE, which may have been selected from the rectangular non-uniform modulation constellation corresponding to the MCS index.

In another example, a BS can pre-determine/configure information about the switching time to a rectangular non-uniform modulation constellation. In this case, operation 1805 may be skipped; a BS can receive modulation symbols from a rectangular non-uniform modulation constellation from a UE at a pre-determined/configured time in operation 1806.

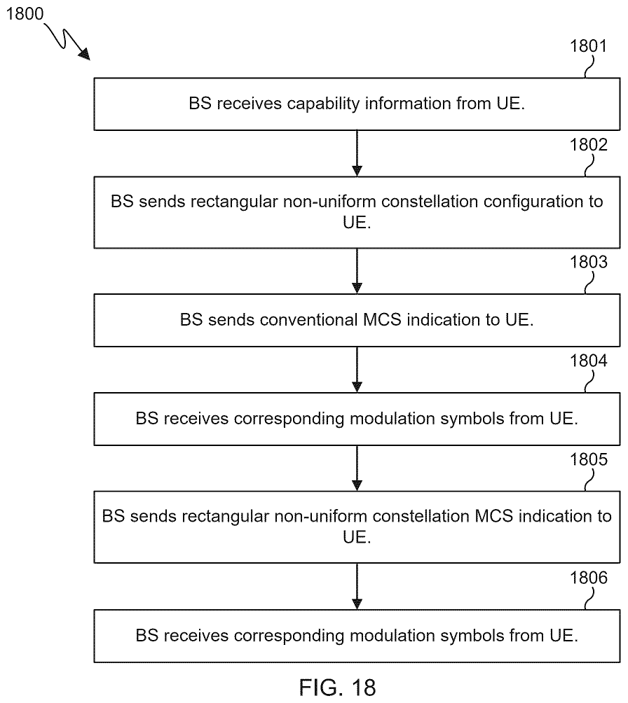

FIG. 19 is a flow diagram illustrating an example of UE operation to support UE-initiated fallback to conventional modulation constellations according to an embodiment of the present disclosure.

FIG. 19 is an example of a method 1900 for operations at a UE to support UE-initiated fallback to a conventional modulation constellation. At operation 1901, a UE sends its capability information to a BS, including the support of rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M≠32 and M≠128.

At operation 1902, a UE receives rectangular non-uniform constellation configuration information from a BS, which can include information such as enabling/disabling of the mapping between an MCS index and a rectangular non-uniform modulation constellation.

At operation 1903, a UE receives an MCS indication message from a BS for a rectangular non-uniform modulation constellation. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 1904, a UE sends modulation symbols to a BS, which may have been selected from the constellation corresponding to the MCS index.

At operation 1905, a UE sends a rectangular non-uniform modulation constellation fallback indication to a BS, which will be described below.

At operation 1906, a UE sends modulation symbols from a conventional modulation constellation to a BS.

In another example, a BS can pre-determine/configure information about the switching time to a conventional modulation constellation. In this case, operation 1905 may be skipped; a UE can send modulation symbols from a conventional modulation constellation to a BS at a pre-determined/configured time in operation 1906.

In another example, between operation 1905 and operation 1906, a UE can perform an operation 1907. In operation 1907, a UE can receive an MCS indication message from a BS for a conventional modulation constellation. The MCS index that corresponds to this message can differ from the MCS index that corresponds to the fallback indication in operation 1905.

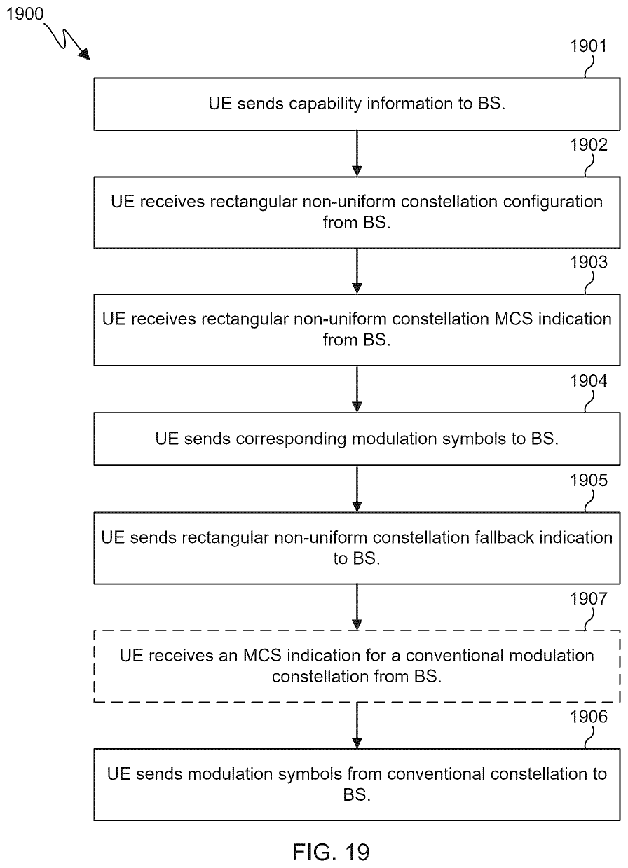

FIG. 20 is a flow diagram illustrating an example of BS operation to support UE-initiated fallback to conventional modulation constellations according to an embodiment of the present disclosure.

FIG. 20 is an example of a method 2000 for operations at a BS to support UE-initiated fallback to a conventional modulation constellation. At operation 2001, a BS receives capability information from a UE, including the support of rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M≠32 and M≠128.

At operation 2002, a BS sends rectangular non-uniform constellation configuration information to a UE, which can include information such as enabling/disabling of the mapping between an MCS index and a rectangular non-uniform modulation constellation.

At operation 2003, a BS sends an MCS indication message to a UE for a rectangular non-uniform modulation constellation. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 2004, a BS receives modulation symbols from a UE, which may have been selected from the constellation corresponding to the MCS index.

At operation 2005, a BS receives a rectangular non-uniform modulation constellation fallback indication from a UE, which will be described below.

At operation 2006, a BS receives modulation symbols from a conventional modulation constellation from a UE.

In another example, a BS can pre-determine/configure information about the switching time to a conventional modulation constellation. In this case, operation 2005 may be skipped; a BS can receive modulation symbols from a conventional modulation constellation from a UE at a pre-determined/configured time in operation 2006.

In another example, between operation 2005 and operation 2006, a BS can perform an operation 2007. In operation 2007, a BS can send an MCS indication message to a UE for a conventional modulation constellation. The MCS index that corresponds to this message can differ from the MCS index that corresponds to the fallback indication in operation 2005.

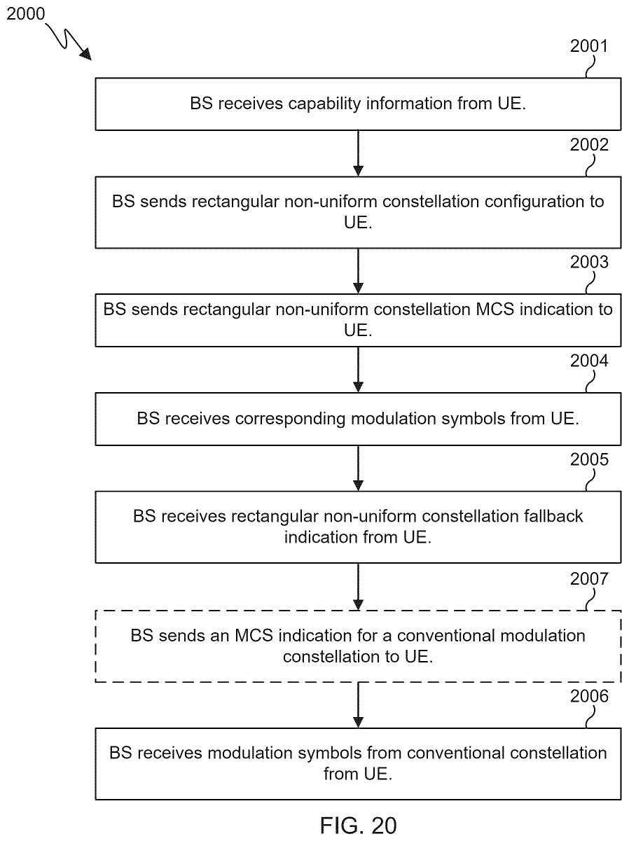

FIG. 21 is a flow diagram illustrating an example of UE operation to support BS-initiated fallback to conventional modulation constellations according to an embodiment of the present disclosure.

FIG. 21 is an example of a method 2100 for operations at a UE to support BS-initiated fallback to a conventional modulation constellation. At operation 2101, a UE sends capability information to a BS, including the support of rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M≠32 and M≠128.

At operation 2102, a UE receives rectangular non-uniform constellation configuration information from a BS, which can include information such as enabling/disabling of the mapping between an MCS index and a rectangular non-uniform modulation constellation.

At operation 2103, a UE receives an MCS indication message from a BS for a rectangular non-uniform modulation constellation. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 2104, a UE sends modulation symbols to a BS, which may have been selected from the constellation corresponding to the MCS index.

At operation 2105, a UE receives a command from a BS to switch to a conventional modulation constellation. In one example, a BS can configure a UE to switch to a conventional modulation constellation via a PDCCH order, where a new DCI format can be defined and this PDCCH order can be triggered by this new DCI format. In another example, a BS can configure a UE to switch to a conventional modulation constellation via an RRC reconfiguration message.

At operation 2106, a UE sends modulation symbols from a conventional modulation constellation to a BS.

In another example, a BS can pre-determine/configure information about the switching time to a conventional modulation constellation. In this case, operation 2105 may be skipped; a UE can send modulation symbols from a conventional modulation constellation to a BS at a pre-determined/configured time in operation 2106.

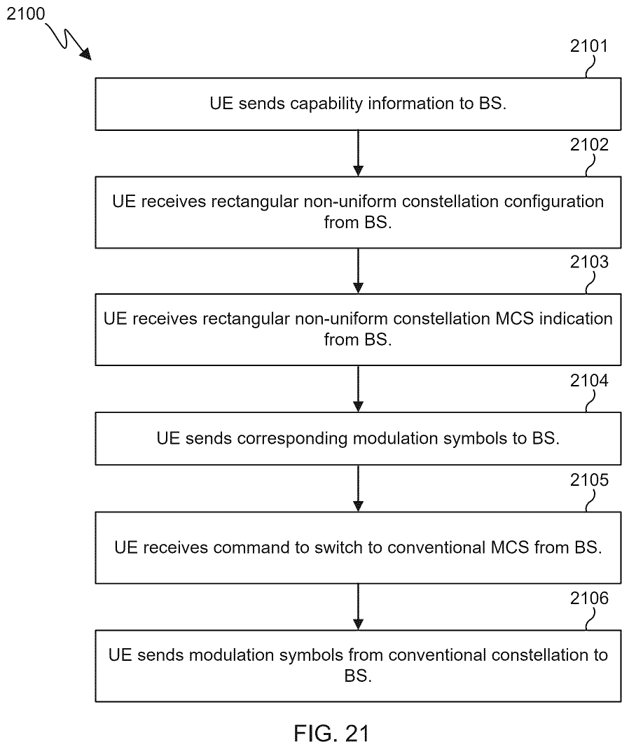

FIG. 22 is a flow diagram illustrating an example of BS operation to support BS-initiated fallback to conventional modulation constellations according to an embodiment of the present disclosure.

FIG. 22 is an example of a method 2200 for operations at a BS to support BS-initiated fallback to a conventional modulation constellation. At operation 2201, a BS receives capability information from a UE, including the support of rectangular non-uniform modulation constellations. In one embodiment, these constellations can include 32-ary constellations, where five bits are mapped to a modulation symbol. In another embodiment, these constellations can include 128-ary constellations, where seven bits are mapped to a modulation symbol. In another embodiment, these constellations can include other modulation constellations with order M, where M is not a power of 4 and M≠32 and M≠128.

At operation 2202, a BS sends rectangular non-uniform constellation configuration information to a UE, which can include information such as enabling/disabling of the mapping between an MCS index and a rectangular non-uniform modulation constellation.

At operation 2203, a BS sends an MCS indication message to a UE for a rectangular non-uniform modulation constellation. A BS can use an existing DCI format for this MCS indication message. The BS can also define a new DCI format for this MCS indication message. In one example, a UE uses this MCS indication message to determine an MCS index. In another example, a UE may autonomously determine an MCS index.

At operation 2204, a BS receives modulation symbols from a UE, which may have been selected from the constellation corresponding to the MCS index.

At operation 2205, a BS sends a command to a UE to switch to a conventional modulation constellation. In one example, a BS can configure a UE to switch to a conventional modulation constellation via a PDCCH order, where a new DCI format can be defined and this PDCCH order can be triggered by this new DCI format. In another example, a BS can configure a UE to switch to a conventional modulation constellation via an RRC reconfiguration message.

At operation 2206, a BS receives modulation symbols from a conventional modulation constellation from a UE.

In another example, a BS can pre-determine/configure information about the switching time to a conventional modulation constellation. In this case, operation 2205 may be skipped; a BS can receive modulation symbols from a conventional modulation constellation from a UE at a pre-determined/configured time in operation 2206.

UE assistance information is considered.

The UE assistance information report offers several advantages over relying on existing signaling. For example, a BS can use SRS to estimate the UL (and DL, depending on reciprocity) channel from a UE. The minimum periodicity of SRS is 2 milliseconds (ms), though; in contrast, the spacing between consecutive DMRS can be configured to be less than 1 ms. Thus, a UE can perform finer-grained measurements of the DL channel using received DMRS, compared to a BS measuring the UL channel using received SRS.

As another example, a UE can report local information that may not be available to a BS. A UE can use its cameras to determine that a vehicle will cross its line-of-sight with a BS in T seconds. A UE can then report this information to a BS and make a pre-emptive recommendation for a modulation constellation switch in T seconds (e.g. switching from a rectangular non-uniform modulation constellation to a conventional modulation constellation).

In one embodiment, a new MAC CE can be defined for the UE assistance information report. This MAC CE can be identified by a MAC subheader with a logical channel ID that can be specified in Table 6.2.1-2 in [3]. This MAC CE can have a variable size and includes the following fields:
UE Trajectory: This field indicates the trajectory of a UE.
   In one example, this could be a set of waypoints for its trajectory based on the programmed destination in its mapping application.
UE-Side Sensing Information: This field indicates information from the sensors on a UE.
   In one example, this could be a message from an onboard radar that the currently-blocked line-of-sight path to a BS will be clear in T seconds.
Information Report (IR): This field indicates the presence of the octet containing the Recommended Rectangular NUC Tx MCS field. If the IR field is set to 1, the octet containing the Recommended Rectangular NUC Tx MCS field is present. If the IR field is set to 0, the octet containing the Recommended Rectangular NUC Tx MCS field is not present.
Recommended Rectangular NUC Tx MCS: This field indicates a UE's recommended MCS index for a rectangular non-uniform modulation constellation, e.g. an index to a table of MCS values for rectangular non-uniform modulation constellations

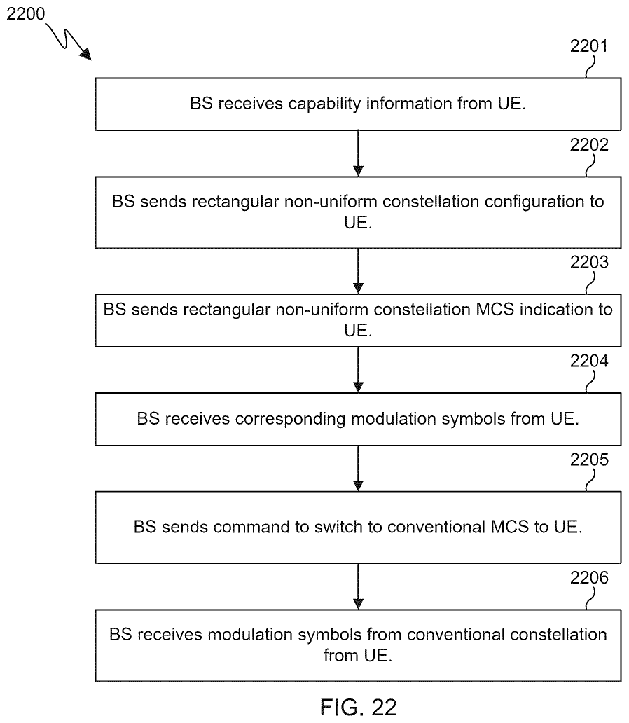

FIG. 23 shows an example of a new MAC CE for the UE assistance information report according to an embodiment of the present disclosure, where the UE Trajectory and UE-Side Sensing Information fields each have a length of 8 bits. The Recommended Rectangular NUC Tx MCS field has a length of 7 bits.

In one embodiment, a BS can configure a UE to send a UE assistance information report via DCI.

Rectangular non-uniform modulation constellation fallback indication is considered.

In one embodiment, a new MAC CE can be defined for the rectangular non-uniform modulation constellation fallback indication. This MAC CE can be identified by a MAC subheader with a logical channel ID. This MAC CE can have a variable size and includes the following fields:
Rectangular NUC Tx Fallback: This field indicates the MCS index that a UE is requesting, e.g. an index to a table of MCS values for conventional modulation constellations.

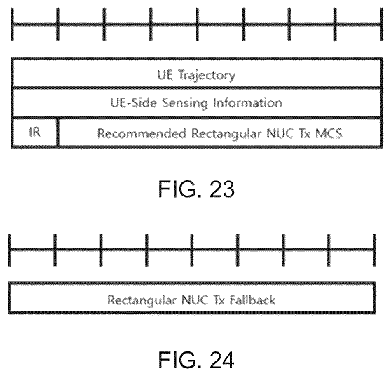

FIG. 24 shows an example of a new MAC CE for the rectangular non-uniform modulation constellation fallback indication according to an embodiment of the present disclosure, where the Rectangular NUC Tx Fallback field has a length of 8 bits.

In one embodiment, a BS can configure a UE to send a rectangular non-uniform modulation constellation fallback indication via DCI.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claim scope. The scope of patented subject matter is defined by the claims.

What is claimed is:

1. A user equipment (UE) comprising:
a transceiver configured to
send, to a base station, capability information including an indication of support for rectangular non-uniform modulation constellations,
receive, from the base station, rectangular non-uniform modulation constellation configuration information, and
receive, from the base station, a modulation and coding scheme (MCS) indication; and
at least one processing device coupled to the transceiver, the at least one processing device configured to map a plurality of bits to be transmitted to a rectangular non-uniform modulation constellation based on the MCS indication,
wherein the transceiver is configured to transmit modulation symbols corresponding to the rectangular non-uniform modulation constellation to which the plurality of bits were mapped.

2. The UE of claim 1, wherein the received rectangular non-uniform modulation constellation configuration information includes one or more of:
information enabling/disabling mapping between an MCS index and a rectangular non-uniform modulation constellation;
an identifier for each of one or more rectangular non-uniform modulation constellations;
one of
an indication of bit-to-symbol mapping tables for each of the one or more rectangular non-uniform modulation constellations, or
an indication of a set of coefficients for bit-to-symbol mappings for each of the one or more rectangular non-uniform modulation constellations.

3. The UE of claim 2, wherein the bit-to-symbol mapping tables for each of the one or more rectangular non-uniform modulation constellations include one or more of:
a set of base points within a first quadrant of a real-imaginary plane and sets of the base points reflected across the real axis and the imaginary axis of the real-imaginary plane, or
a set of shifted points within a first quadrant of a real-imaginary plane, the shifted points corresponding to original points shifted by specified amounts, and sets of the shifted points reflected across the real axis and the imaginary axis of the real-imaginary plane.

4. The UE of claim 1, wherein:
the received MCS indication is not a rectangular non-uniform modulation constellation MCS indication, and
the transceiver is further configured to
send, to the base station, first modulation symbols corresponding to the received MCS indication that is not a rectangular non-uniform modulation constellation MCS indication,
receive, from the base station, a rectangular non-uniform modulation constellation MCS indication, and
transmit second modulation symbols based on the rectangular non-uniform modulation constellation MCS indication.

5. The UE of claim 4, wherein the transceiver is further configured to send, to the base station, assistance information in response to receiving the MCS indication that is not a rectangular non-uniform modulation constellation MCS indication, wherein the assistance information includes at least one of UE trajectory, UE sensor information, or information corresponding to one or more recommended rectangular non-uniform modulation constellations.

6. The UE of claim 1, wherein the transceiver is further configured to:
send, to the base station, a rectangular non-uniform modulation constellation fallback indication, wherein the rectangular non-uniform modulation constellation fallback indication comprises an index to a table of MCS index values that do not correspond to rectangular non-uniform modulation constellations, wherein the MCS index values correspond to constellations requested by the UE for UE-initiated fallback, and
send, to the base station, modulation symbols corresponding to a modulation constellation that is not a rectangular non-uniform modulation constellation.

7. The UE of claim 1, wherein the transceiver is further configured to:
receive, from the base station, a command to switch to an MCS that does not correspond to rectangular non-uniform modulation constellations, and
transmit modulation symbols based on the MCS that does not correspond to rectangular non-uniform modulation constellations.

8. A method performed by a user equipment (UE) in a wireless communications system, the method comprising:
sending, to a base station, capability information including an indication of support for rectangular non-uniform modulation constellations;
receiving, from the base station, rectangular non-uniform modulation constellation configuration information;
receiving, from the base station, a modulation and coding scheme (MCS) indication;
mapping a plurality of bits to be transmitted to a rectangular non-uniform modulation constellation based on the MCS indication; and
transmitting modulation symbols corresponding to the rectangular non-uniform modulation constellation to which the plurality of bits were mapped.

9. The method of claim 8, wherein the received rectangular non-uniform modulation constellation configuration information includes one or more of:
information enabling/disabling mapping between an MCS index and a rectangular non-uniform modulation constellation;
an identifier for each of one or more rectangular non-uniform modulation constellations;
one of
an indication of bit-to-symbol mapping tables for each of the one or more rectangular non-uniform modulation constellations, or
an indication of a set of coefficients for bit-to-symbol mappings for each of the one or more rectangular non-uniform modulation constellations.

10. The method of claim 9, wherein the bit-to-symbol mapping tables for each of the one or more rectangular non-uniform modulation constellations include one or more of:
a set of base points within a first quadrant of a real-imaginary plane and sets of the base points reflected across the real axis and the imaginary axis of the real-imaginary plane, or
a set of shifted points within a first quadrant of a real-imaginary plane, the shifted points corresponding to original points shifted by specified amounts, and sets of the shifted points reflected across the real axis and the imaginary axis of the real-imaginary plane.

11. The method of claim 8, wherein the received MCS indication is not a rectangular non-uniform modulation constellation MCS indication, and wherein the method further comprises:
sending, to the base station, first modulation symbols corresponding to the received MCS indication that is not a rectangular non-uniform modulation constellation MCS indication;
receiving, from the base station, a rectangular non-uniform modulation constellation MCS indication; and
transmitting second modulation symbols based on the rectangular non-uniform modulation constellation MCS indication.

12. The method of claim 11, further comprising:
sending, to the base station, assistance information in response to receiving the MCS indication that is not a rectangular non-uniform modulation constellation MCS indication, wherein the assistance information includes at least one of UE trajectory, UE sensor information, or information corresponding to one or more recommended rectangular non-uniform modulation constellations.

13. The method of claim 8, further comprising:
sending, to the base station, a rectangular non-uniform modulation constellation fallback indication, wherein the rectangular non-uniform modulation constellation fallback indication comprises an index to a table of MCS index values that do not correspond to rectangular non-uniform modulation constellations, wherein the MCS index values correspond to constellations requested by the UE for UE-initiated fallback; and
sending, to the base station, modulation symbols corresponding to a modulation constellation that is not a rectangular non-uniform modulation constellation.

14. The method of claim 8, further comprising:
receiving, from the base station, a command to switch to an MCS that does not correspond to rectangular non-uniform modulation constellations; and
transmitting modulation symbols based on the MCS that does not correspond to rectangular non-uniform modulation constellations.

15. A base station (BS) comprising:
at least one processing device;
a transceiver coupled to the at least one processing device, the transceiver configured to
receive, from a user equipment (UE), capability information including an indication of support for rectangular non-uniform modulation constellations,
send, to the UE, rectangular non-uniform modulation constellation configuration information, and
send, to the UE, a modulation and coding scheme (MCS) indication, wherein a plurality of bits to be transmitted are mapped to a rectangular non-uniform modulation constellation based on the MCS indication, and
receive modulation symbols corresponding to the rectangular non-uniform modulation constellation to which the plurality of bits were mapped.

16. The BS of claim 15, wherein the received rectangular non-uniform modulation constellation configuration information includes one or more of:
information enabling/disabling mapping between an MCS index and a rectangular non-uniform modulation constellation;
an identifier for each of one or more rectangular non-uniform modulation constellations;
one of
an indication of bit-to-symbol mapping tables for each of the one or more rectangular non-uniform modulation constellations, or
an indication of a set of coefficients for bit-to-symbol mappings for each of the one or more rectangular non-uniform modulation constellations.

17. The BS of claim 16, wherein the bit-to-symbol mapping tables for each of the one or more rectangular non-uniform modulation constellations include one or more of:
a set of base points within a first quadrant of a real-imaginary plane and sets of the base points reflected across the real axis and the imaginary axis of the real-imaginary plane, or
a set of shifted points within a first quadrant of a real-imaginary plane, the shifted points corresponding to original points shifted by specified amounts, and sets of the shifted points reflected across the real axis and the imaginary axis of the real-imaginary plane.

18. The BS of claim 15, wherein:
the received MCS indication is not a rectangular non-uniform modulation constellation MCS indication, and
the transceiver is further configured to
receive, from the UE, first modulation symbols corresponding to the received MCS indication that is not a rectangular non-uniform modulation constellation MCS indication,
send, to the UE, a rectangular non-uniform modulation constellation MCS indication, and
receive second modulation symbols based on the rectangular non-uniform modulation constellation MCS indication.

19. The BS of claim 18, wherein the transceiver is further configured to receive, from the UE, assistance information in response to receiving the MCS indication that is not a rectangular non-uniform modulation constellation MCS indication, wherein the assistance information includes at least one of UE trajectory, UE sensor information, or information corresponding to one or more recommended rectangular non-uniform modulation constellations.

20. The BS of claim 15, wherein the transceiver is further configured to:
receive, from the UE, a rectangular non-uniform modulation constellation fallback indication, wherein the rectangular non-uniform modulation constellation fallback indication comprises an index to a table of MCS index values that do not correspond to rectangular non-uniform modulation constellations, wherein the MCS index values correspond to constellations requested by the UE for UE-initiated fallback, and
receive, from the UE, modulation symbols corresponding to a modulation constellation that is not a rectangular non-uniform modulation constellation.
